(19) United States
(12) Patent Application Publication
(10) Pub. No.: US 2024/0313827 A1
(43) Pub. Date: Sep. 19, 2024

(54) MODULAR ACCESS POINT

(71) Applicant: CommScope Technologies LLC, Claremont, NC (US)

(72) Inventors: Rainer Friedrich, Maihingen (DE); Patrick Braun, Munningen (DE); Karl-Heinz Fackler, Wemding (DE); Alfons Dussmann, Gansheim (DE); Joerg Stefanik, Donauworth (DE); Christoph Gollinger, Bayern (DE)

(73) Assignee: CommScope Technologies LLC, Claremont, NC (US)

(21) Appl. No.: 18/607,234

(22) Filed: Mar. 15, 2024

Related U.S. Application Data
(60) Provisional application No. 63/490,989, filed on Mar. 17, 2023.

(51) Int. Cl. H04B 7/022; H04B 1/04

(52) U.S. Cl. CPC H04B 7/022; H04B 1/0475; H04B 2001/0408

(57) ABSTRACT

Systems and methods for a modular access point are provided. In certain embodiments, a device includes a housing. Further, the device includes a baseband card (BBC) mounted within the housing, wherein the modular BBC has one or more interfaces. Additionally, the device includes one or more radio modules, wherein at least one radio module in the one or more radio modules is coupled to an interface in the one or more interfaces, wherein the one or more interfaces are capable of connecting to multiple different power classes of radio modules. Moreover, the device includes one or more additional components in communication with the modular BBC through the one or more interfaces that support the operation of a radio module in a respective power class.

### CROSS-REFERENCE TO RELATED APPLICATIONS

This application claims priority to U.S. Provisional Application No. 63/490,989, filed on Mar. 17, 2023, and titled “MODULAR ACCESS POINT,” the contents of which are incorporated by reference herein in their entirety.

### BACKGROUND

A distributed antenna system (DAS) can be used to extend the coverage of a cellular communication system to areas of traditionally low signal coverage, such as within buildings, tunnels, or areas obstructed by terrain features. A DAS can extend coverage by receiving signals from a base station of a cellular communication system and retransmitting the signals directly into low-coverage areas. For example, a DAS can include a main unit that receives signals from one or more base stations, distributes the received signals into the coverage area through multiple access points, and transmits signals from the access points to a base station. The access points are located to distribute signals to and receive signals from user equipment in a coverage area.

When distributing signals into a coverage area, access points and other DAS components may be designed to have different form factors by power classes. Within the different power classes, DAS components may use different passive and active cooling systems. Because of the different requirements imposed by the shape of the device and the components required due to the power class of the device, different devices may have components individually designed for the different types of classes.

### SUMMARY

Systems and methods for a modular access point are provided. In certain embodiments, a device includes a housing. Further, the device includes a baseband card (BBC) mounted within the housing, wherein the modular BBC has one or more interfaces. Additionally, the device includes one or more radio modules, wherein at least one radio module in the one or more radio modules is coupled to an interface in the one or more interfaces, wherein the one or more interfaces are capable of connecting to multiple different power classes of radio modules. Moreover, the device includes one or more additional components in communication with the modular BBC through the one or more interfaces that support the operation of a radio module in a respective power class.

### BRIEF DESCRIPTION OF THE DRAWINGS

Drawings accompany this description and depict only some embodiments associated with the scope of the appended claims. Thus, the described and depicted embodiments should not be considered limiting in scope. The accompanying drawings and specification describe the exemplary embodiments, and features thereof, with additional specificity and detail, in which:

FIG. 1 is a block diagram of a communication system using a distributed antenna system according to an aspect of the present disclosure;

FIG. 2 is an exploded view of an access point having modular components according to an aspect of the present disclosure;

FIGS. 3A-3C illustrate various views of access points of different power classes having modular components according to an aspect of the present disclosure;

FIGS. 4A-4C illustrate a schematic of a typical serial peripheral interface;

FIGS. 4D-4F illustrate various schematics for implementing serial peripheral interfaces with line decoders according to an aspect of the present disclosure;

FIG. 5 is a block diagram of a reconfigurable interface according to an aspect of the present disclosure;

FIGS. 6A and 6B are block diagrams illustrating different duplexing schemes that implement reflective splitting and/or combining amplification according to an aspect of the present disclosure;

FIG. 7 is a diagram of multiple power pallets within a housing according to an aspect of the present disclosure;

FIG. 8 is a block diagram of a modular amplifier according to an aspect of the present disclosure;

FIG. 9 is a block diagram illustrating the implementation of a digital predistortion switch according to an aspect of the present disclosure;

FIGS. 10A-10C are diagrams illustrating the location of various components of a high-power access point according to an aspect of the present disclosure;

FIG. 11 is a diagram illustrating the connection of multiple components through various interfaces within an access point according to an aspect of the present disclosure;

FIG. 12 is a flowchart diagram of a method for receiving signals within an access point having modular components according to an aspect of the present disclosure.

Per common practice, the drawings do not show the various described features according to scale, but the drawings show the features to emphasize the relevance of the features to the example embodiments.

### DETAILED DESCRIPTION

The following detailed description refers to the accompanying drawings that form a part of the present specification. The drawings, through illustration, show specific illustrative embodiments. However, it is to be understood that other embodiments may be used and that logical, mechanical, and electrical changes may be made.

Systems and embodiments described herein provide for modular components that can be used in multiple access point types. For example, distributed antenna systems (DAS) frequently include carrier access points that distribute signals throughout a coverage area. Additional systems, like OneCell, may also include multiple access points. The access points of the various systems can be in multiple power classes, such as low-power, medium-power, or high-power access points. Access points for these different power classes have different design considerations. In particular, the different design considerations allow for the power and components that provide the functions of the respective power classes and also permit the related passive or active cooling. Thus, each power class may have different components and different form factors to enclose and support the different components.

Although the access points for different power classes have different design considerations, the access points have common components that perform similar functions. For example, access points from the different power classes include baseband cards and radio modules. The present disclosure describes systems and methods that allow for the modular design of common components so that the modular components of the same design can be installed in access points subject to different design constraints, such as those related to power class and form factor. By using modular components, manufacturers can reduce costs when designing and manufacturing access points of the various power classes and form factors.

One of the key components of an access point is a baseband card (BBC). The BBC is coupled to communicate baseband, IF, or RF signals with components in the DAS bi-directionally. For example, a BBC can receive baseband downlink signals from a main unit, intermediate unit, and the like for wireless transmission to user equipment or other wireless devices. In the uplink direction, the BBC can transmit baseband uplink signals to the main unit, intermediate unit, and the like, where the baseband uplink signals are down-converted uplink signals received from user equipment. Also, the BBC can receive power for distribution to various components connected to the BBC within an access point. As a BBC is a common component in access points regardless of power class, frequency coverage, communication standards, UL/DL duplex technology, and modulation scheme, the BBC can be designed as a modular component for use in multiple different types of access point designs.

As part of the function of the BBC, the BBC can be coupled to multiple RF radio modules through one or more interfaces. The radio modules may be configured to convert signals between baseband or intermediate frequency and the carrier frequency for transmission by one or more antennas to user equipment within a coverage area associated with the access point based on the connected interfaces. Also, the radio modules may amplify radio frequency signals based on the connected interfaces. The connected interfaces may include RF in and RF out, IF in and RF out, baseband in and IF out, or baseband in and RF out. The BBC provides DC power supply, distribution to connected devices, and addressing for any connected radio modules while also controlling the radio modules. Further, the BBC may be capable of connecting different types of radio modules through an interface. Thus, a modular BBC allows for a quick and flexible way to combine multiple frequency bands, along with time-division duplexing (TDD) or frequency-division duplexing (FDD) standards through a single BBC design, where the differences in implementations can be accommodated by a single software/FPGA load onto the BBC that can accommodate multiple multiplexing schemes, power classes, and hardware configurations.

In certain embodiments, the BBC may control connected devices through an expansion control interface to support the modularity of the BBC. For example, the BBC may communicate with and control connected devices through a serial peripheral interface (SPI). The SPI control may be distributed from the BBC to the radio modules and extended to devices connected to the radio modules, such as high-power pallets used in high-power class access points. The SPI interface may include a dedicated enable signal for each connected device. The SPI interface may be expandable by including a combination of logic gates and x-to-y line decoders, which expand the bus based on the position of a connector. An x-to-y line decoder decodes x binary weighted address inputs to y mutually exclusive outputs. Thus, different modules can be connected on different connectors, and the hardware may be able to expand the number of connected and addressable devices without additional reconfiguration.

In exemplary embodiments, a digital predistortion (DPD) feedback path can be adapted for modular radio modules. Frequently, DPD is applied to signals before being coupled into an amplifier to account for non-linear amplification and other distortions that occur during amplification. A system may identify the appropriate predistortion by coupling the amplified signal into a DPD feedback path, where the amplified signal can be compared against the original signal. In the modular concepts described herein, the DPD feedback path can be adapted for a medium-power radio module or a high-power pallet. For example, a high-power observation path can be connected to a medium-power radio module, such that the system reuses the design of the medium-power card with an RF switch or an assembly on a printed circuit board. Running the DPD feedback path from the high-power pallet through the reused medium-power radio modules may reduce the complexity and costs of high-power pallet designs. The reduced complexity also reduces the layer stack-up of the PCBs, which can improve cooling.

In some embodiments, the BBC may connect to different devices in different orientations to facilitate the installation of the BBC in different form factors. For example, the BBC may connect to radio modules and other components in a straight 180° orientation. Alternatively, the BBC may connect to radio modules and other components in a 90° orientation. Where the 90° and 180° orientations have a pin-to-pin relationship with each other, and the connectors are within the same footprint. Thus, when designing, components connected to the BBC can be connected in a 180° or 90° orientation to facilitate passive or active cooling. Additionally, the BBC can connect to components in a combination of 90° and 180° to facilitate installation in customized housings associated with different power classes.

In a further embodiment, an entry module can be designed to connect to the BBC in existing access point connectors while maintaining the modularity of the BBC. An entry module is a module that connects to the BBC that provides an interface between various connectors that connect to the access point. For example, the entry module may receive power (like power over ethernet (POE) or through other types of connections) and data (like through ethernet, fiber optic, coaxial, etc.) and provide power and data connections to the BBC. In some current designs, an entry module may connect to the BBC in different positions. Thus, at least one radio module slot may be reconfigured to connect to an entry module as well as a radio module.

In certain embodiments, one or more connector interfaces of a BBC may be reconfigurable. For example, the BBC may connect to different modules based on the design of the associated access point. As one or more of the connector interfaces are reconfigurable, the interfaces can be reconfigured to support different modules in different applications. In some implementations, the interfaces can be reconfigured by hardware, software, and field programmable gate arrays (FPGA). Additionally, the BBC may include FPGAs and processor(s) as part of a radio frequency system-on-chip (RFSOC).

In additional embodiments, the BBC card can connect to radio modules that function as a driver for higher-power radio modules. For example, the BBC can connect to a medium-power radio module that connects to a high-power pallet. The medium-power radio module may function as a driver stage for the high-power pallet. Further, as already discussed, a DPD feedback path from the high-power pallet through the medium-power radio module may allow suitable corrections of amplifier nonlinearities over multiple single-input, single-output (SISO) bands or a multiband DAS application.

Further, typical systems perform signal processing in an FPGA located on the BBC. Signal processing may include serializing, de-serializing, filtering, and data rate conversion, among other processing tasks. Performing most of the different processing tasks within an FPGA may limit a system's bandwidth due to the limited FPGA resources. Also, FPGAs consume power less efficiently than ASIC implementations. Additionally, radio modules have integrated transceiver chips with signal processing capabilities that can perform digital-up-conversion/digital-down-conversion (DUC/DDC), fast Fourier transformation/inverse fast Fourier transformation (FFT/IFFT), crest factor reduction (CFR), DPD, interpolation, decimation, among other processing capabilities. The FPGA and other processors on the BBC may outsource tasks that can be performed by the transceiver chips on radio modules to connected radio modules. Outsourcing some of the signal processing steps from the BBC to integrated transceiver chips can increase the bandwidth capabilities and lower the power consumption of the BBC.

In some embodiments, when signals are received by an access point, a radio module can receive multiple signals at different bands and reflectively combine the different signals for a wideband system. The different bands can be combined in both FDD and TDD schemes. Additionally, in FDD schemes, uplink and downlink signals can be isolated from one another to reduce DPD reflected power and to improve DPD cancellation in reflective combining mode. Further, some components, such as high-power pallets, can have a modular duplexer integrated into the same housing to reduce the loss at the output of the high-power amplifier.

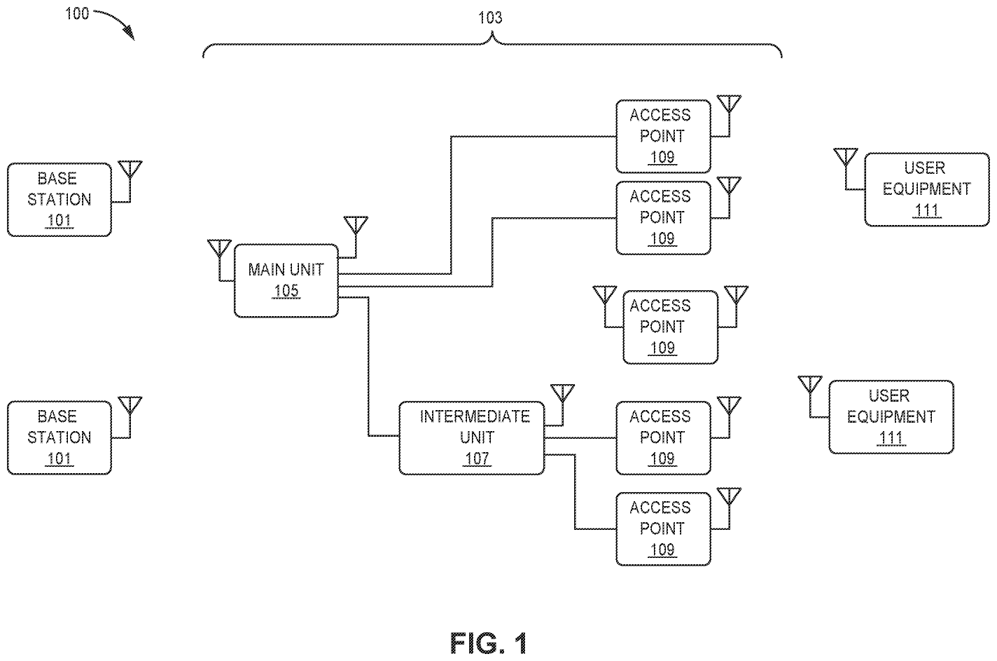

FIG. 1 is a block diagram of a communication system 100 depicting an example of a DAS 103 in communication with one or more base stations 101, which may be base transceiver stations. The DAS 103 can include a main unit 105, access points 109, and an intermediate unit 107. The DAS 103 may be positioned in an area of low signal coverage, such as the interior of a building, to extend wireless communication coverage. Extending wireless coverage can include communicating signals between the base stations 101 and the user equipment 111 positioned in a coverage area of the DAS 103.

The main unit 105 can receive downlink signals from one or more base stations 101 via a wired or wireless communication medium. The main unit 105 can also provide uplink signals to the base stations 101.

The main unit 105 can communicate uplink and downlink signals between the base stations 101 and one or more access points 109 distributed in the environment to provide coverage within a service area of the DAS 103.

The main unit 105 can convert downlink signals received from the base stations 101, such as RF signals, CPRI, ORAN, eCPRI, OBSAI, or RoF, into one or more digital data streams. A group of signals represented by digital data streams can form a band set. The main unit 105 can include circuitry, such as summers or multiplexers, configured to combine the digital data streams within a band set into a band stream. The band stream may be a single digital data stream that includes the digital data streams representing the signals in a band set. In some aspects, combining the digital data streams can include summing or adding signals within a band set. In other aspects, combining the digital data streams can include multiplexing the digital data streams into a serialized band stream.

The main unit 105 can provide downlink signals, such as digital data streams, to some of the remote units, such as the access points 109, via an intermediate unit 107. A non-limiting example of an extension unit is a transport extension node. The intermediate unit 107 can increase the number of the accesses points 109 connectable to the main unit 104 and can potentially extend the range of the main unit 105. A main unit 105 may transmit optical downlink signals over an optical fiber link to intermediate unit 107. The intermediate unit 107 can convert the optical downlink signals to electrical downlink signals and provide the electrical downlink signals to the access points 109 over copper cables, such as a coaxial cable or other suitable communication media.

The main unit 105 can also directly provide downlink signals to the access points, such as access points 109. Directly providing downlink signals can include, for example, communicating the downlink signals from the main unit 105 to the access points 109 without the downlink signals being received by a separate communication device, such as a transport extension node or other device, in the signal path between the main unit 105 and an access point 109.

The access points 109 can convert digital data streams to RF signals. The access points 109 can amplify the downlink signals and radiate the downlink signals using antennas to user equipment 111, such as (but not limited to) cellular phones, operating in the environment of the DAS 103.

In an uplink direction, the access points can receive uplink RF signals, convert them to digital data streams, and provide the uplink digital data streams to the main unit 105 or the intermediate unit 107. The intermediate unit 107 can combine uplink digital data streams into combined digital data streams by summing the IQ data of the individual uplink data streams, such as band streams, and provide the combined digital data streams to the main unit 105. In some aspects, the main unit 105 can convert uplink digital data streams received from the access points 109 or the intermediate unit 107 into uplink RF signals. The main unit 105 can provide the uplink RF signals to the base stations 101. In other aspects, the main unit 105 can convert uplink digital data streams received from the access points 109 into digital signals formatted for transmission to the base stations 101 that communicate using digital signals in a standardized digital format (like CPRI, ORAN, eCPRI, OBSAI) or otherwise.

The main unit 105, intermediate unit 107, and access points 109 can communicate via communication transport links. A communication transport link can include one or a series of physical connections over which a remote unit can communicate with the main unit 105 directly or through the intermediate unit 107. A communication transport link can include any type of communication medium capable of transporting signals between the main unit 105, the intermediate unit 107, or the access points 109.

Although the DAS 103 is depicted as including one main unit 105, one intermediate unit 107, and five access points 109, any number (including one) of each can be used. For example, a DAS 103 may include dozens of intermediate units and hundreds of access points. Additionally, the access points 109 may be of any type of power class.

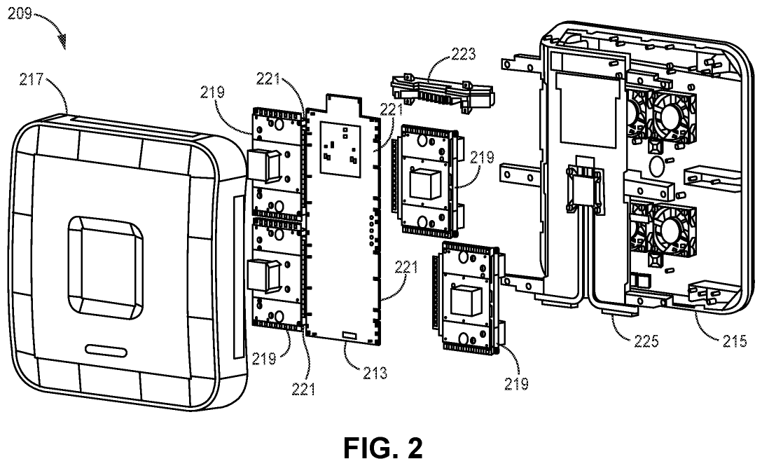

FIG. 2 is an exploded view of an access point 209 with a modular BBC 213. As shown, the access point 209 may include a housing composed of a back housing 215 and a front housing 217. The housing may enclose the components of the 209 and protect the components from the effects of an external environment. Also, the housing may be capable of removing heat generated by the operation of the interior components and radiating the heat into the external environment. For example, the housing may include heat sinks that conduct heat away from the components, openings that allow external air to pass over the components, fans that force air from outside the housing to mix with the air inside the housing, and the like. Additionally, the housing may include connectors that allow other systems to connect to the access point 209. For example, external systems can be coupled to a connector on the housing, where the housing couples the connector to an interior component of the access point 209.

In certain embodiments, the components may include a BBC 213 and radio modules 219. The BBC 213 may be designed using a modular design that allows the BBC 213 to be installed in multiple different types of access points while providing connections to various components through separate interfaces 221. For example, the BBC 213 may have four interfaces 221, that can each connect to separate radio modules 219, where each radio module 219 may facilitate communications in different frequency bands. In one exemplary implementation, where the BBC 213 connects to four radio modules 219, the BBC 213 may control and address the radio modules 219 while supporting a bandwidth that depends on the data rate of FPGA and transceiver chips. Additionally, different interfaces 221 can be combined to increase the bandwidth of a connection through the access point 209. For example, the BBC 213 can use two interfaces 221 to support twice the bandwidth in the uplink and downlink direction. Also, the BBC 213 may communicate through different interfaces 221 using different communication standards, which interfaces may be a JESD 204b, JESD 204c, LVDS serial/parallel interface. For example, the BBC 213 may communicate through a first interface 221 coupled to a radio module 219 and through a second interface 221 coupled to another radio module 219, where the first interface 221 and second interface 221 use different communication standards. Additionally, the first and second interfaces 221 may each support different multiplexing schemes for different mobile operator bands, such as TDD and FDD.

Additionally, each interface 221 may support connections to radio modules 219 with different pin configurations. For example, an interface 221 may support connecting to a radio module 219 having a 98-pin connector (i.e., LVDS serial/parallel interface) and a radio module 219 having a 164-pin connector (i.e., JESD 204B/JESD 204C). Some of the pins (such as a pin-out) may be unified for the different radio modules 219. The different radio modules 219 may receive and transmit various SISO or MIMO communications across different operating bands/signals. Additionally, the BBC 213 may include a data and power interface 223 for connecting to data power and entry modules (DPEM). Through the data and power interface 223, the BBC 213 may receive power over ethernet (POE), connect to an external power supply unit, or receive power through other types of connections. Also, the BBC 213 may receive and transmit data through the data and power interface 223 through various connections that may include coaxial cable, ethernet cables, fiber optic cables, and other wired connections such as SFP+/CSFP+ interfaces. Further, the access point 209 may include an additional heat dissipation board 225 that includes heat sinks, heat tubes, and other heat-conducting components for conducting heat generated in electrical components for dissipation into the external environment. While not shown, in some optional implementations, the housing may also enclose a band combiner for connecting to an external antenna. Thus, the modularity of the BBC 213 and potentially connected radio modules 219 allows a flexible, quick way to combine multiple frequency bands and TDD or FDD standards within an access point, such as the access point 209.

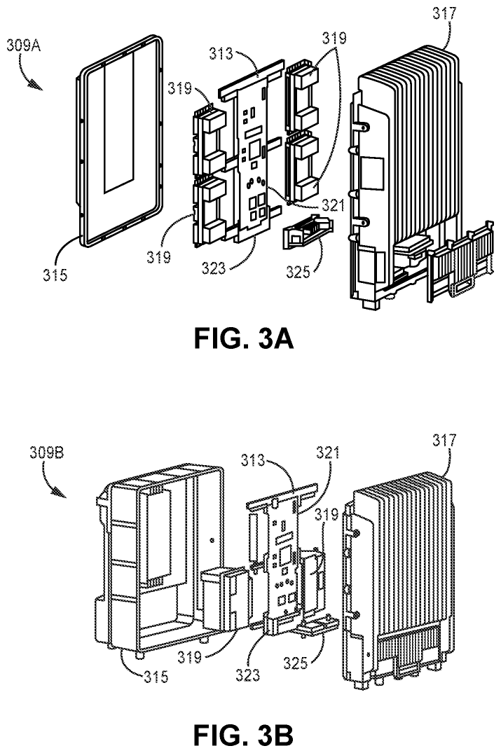

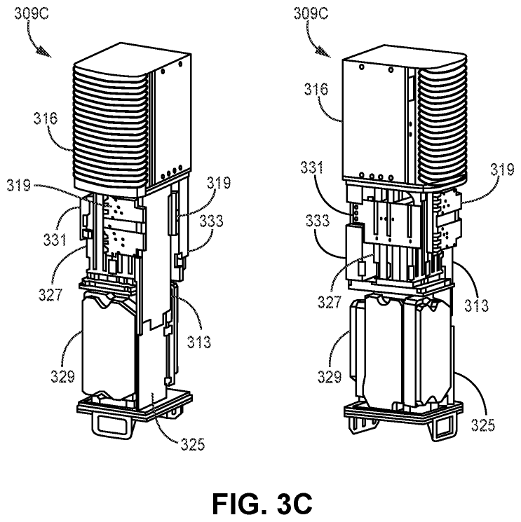

FIGS. 3A-3C illustrate various views of access points of different power classes having modular components. For example, FIG. 3A illustrates a low-power access point 309A, FIG. 3B illustrates a medium-power access point 309B, and FIG. 3C illustrates different views of a high-power access point 309C. The low-power access point 309A, medium-power access point 309B, and high-power access point 309C each contain a modular BBC 313. The BBC 313 may function as described above with respect to the BBC 213 in FIG. 2.

In FIGS. 3A and 3B, in addition to the BBC 313, the low-power access point 309A and the medium-power access point 309B include many of the components described above in FIG. 2. For example, the radio module 319 and the data and power entry module (DPEM) 325 of the low-power access point 309A may be similar to the radio module 219 and a DPEM module on the access point 209 in FIG. 2. Also, components of the low-power access point 309A may be similar to the medium-power access point 309B in FIG. 3B. For example, the front housing 317, BBC 313, data and power interface 323, and DPEM 325 may be similar within either the low-power access point 309A or the medium-power access point 309B. Further, the medium-power access point 309B may have different filters assembled on a PCB as compared to the low-power access point 309A and the radio module 219. Additionally, as illustrated, both the low-power access point 309A and medium-power access point 309B include the aforementioned DPEM 325 coupled to the data and power interface 323 of the respective BBC 313. In some embodiments, the DPEM 325 may be the same for both the low-power access point 309A and the medium-power access point 309B. As illustrated, the BBC 313 found in the low-power access point 309A and in the medium-power access point 309B may be cut using a common die tool.

In FIG. 3C, the high-power access point 309C may have modular radio modules 319 that function in a similar manner to the radio modules 319 in FIGS. 3A and 3B. The radio modules receive the signals from the BBC 313 and function as a driver stage for additional amplification by power pallets 327. The radio modules on the power pallets 327 amplify the signals for transmission into a larger coverage area, where the structure of the power pallets 327 facilitates active cooling of the radio modules 319 and amplification stages on the power pallets 327, wherein the active cooling may be provided by a cooling section 316. Additionally, in contrast to the low-power access point 309A and medium-power access point 309B, a DPEM 325 may couple to an interface that could also couple to one of the radio modules in such a way that the DPEM 325 and BBC 313 are mounted in a 180° orientation on the high-power access point 309C as compared to mounted in a 90° orientation in the low-power access point 309A and the medium-power access point 309B. Moreover, the DPEM 325 and the BBC 313 may be connected to a reconfigurable radio slot or a slot dedicated to the DPEM 325. Further, the 309C may include additional components such as filters 329 and other RF components than those found in the medium-power access point 309B and the low-power access point 309A. Moreover, the high-power access point 309C may have power distribution components, such as a power supply 333 and power and data distribution board (PDDB) 331, wherein the PDDB 331 distributes power to the various components in the high-power access point 309-C and also distributes data to the pertinent components in the high-power access point 309-C. Using a modular BBC 313 in the access points 309-A-309-C, allows the access points of various power classes to reuse HW, FPGAs, and SW on the different access points.

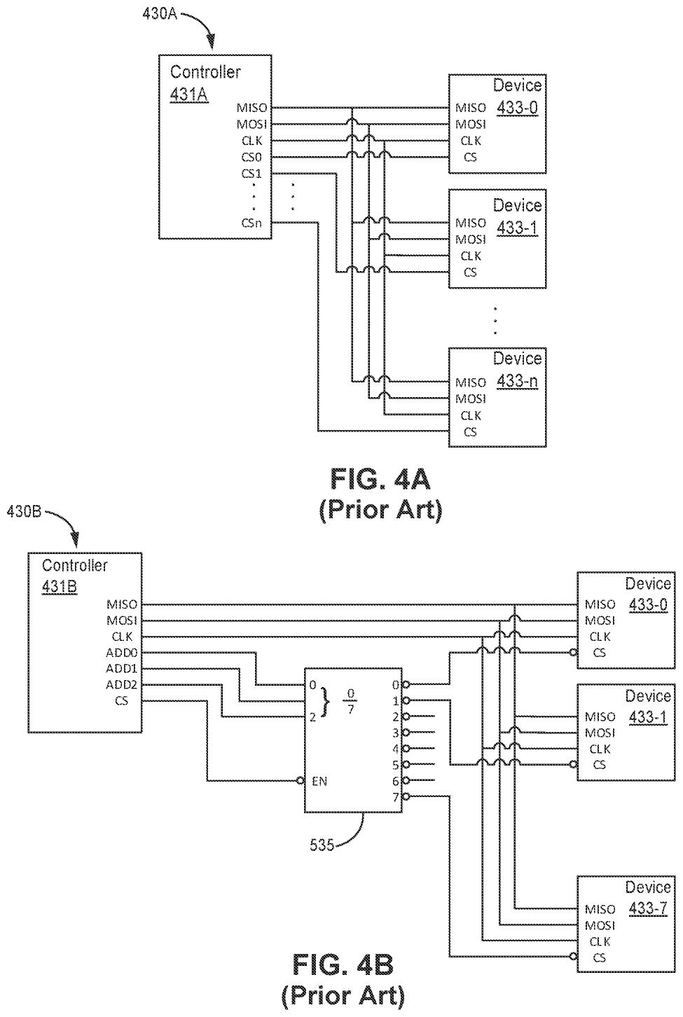

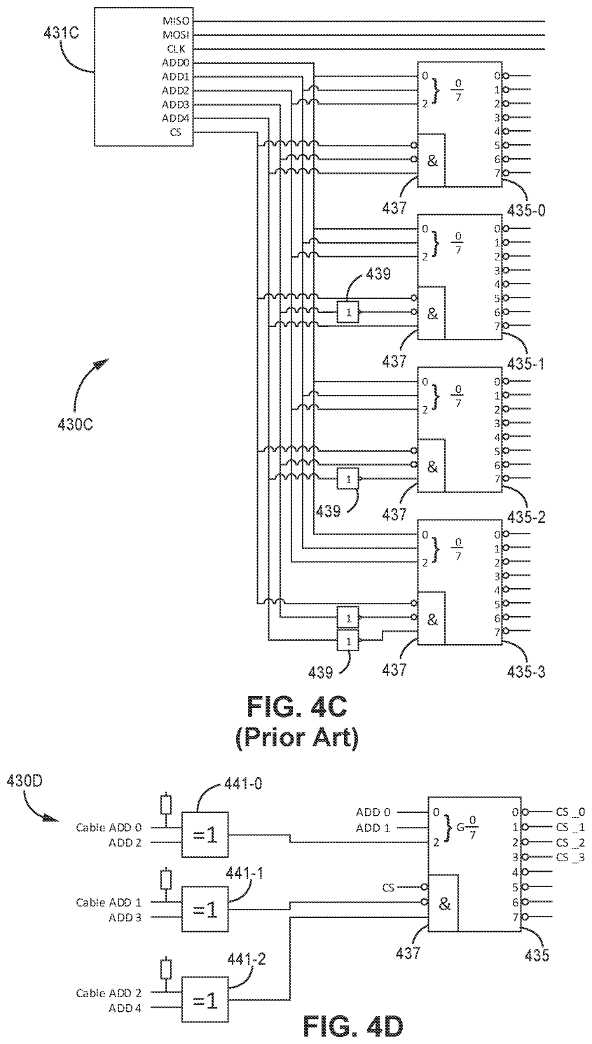

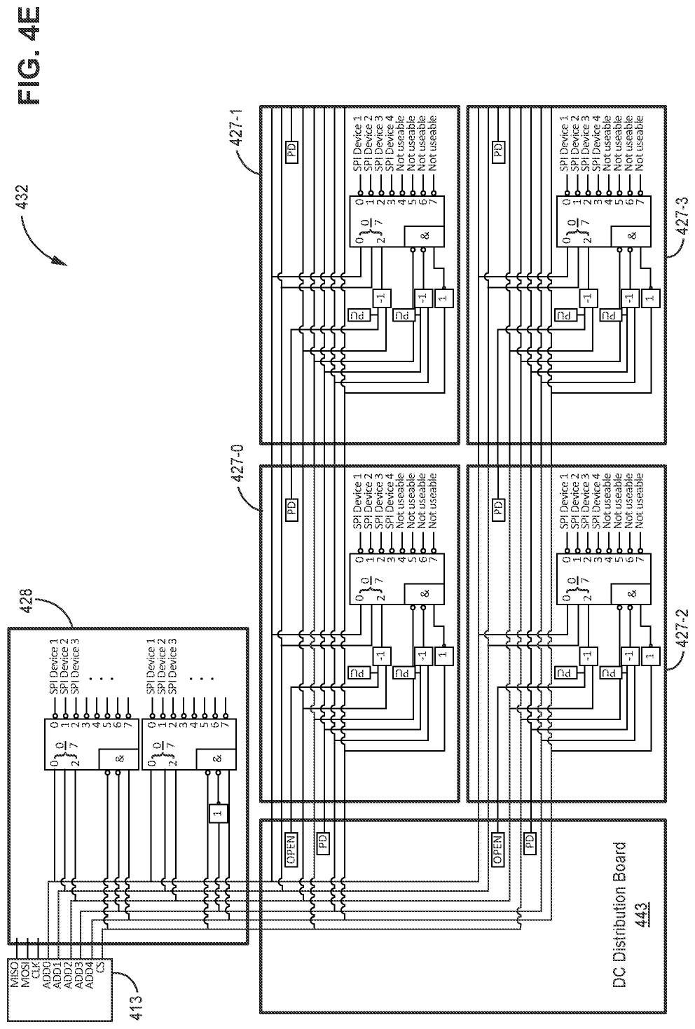

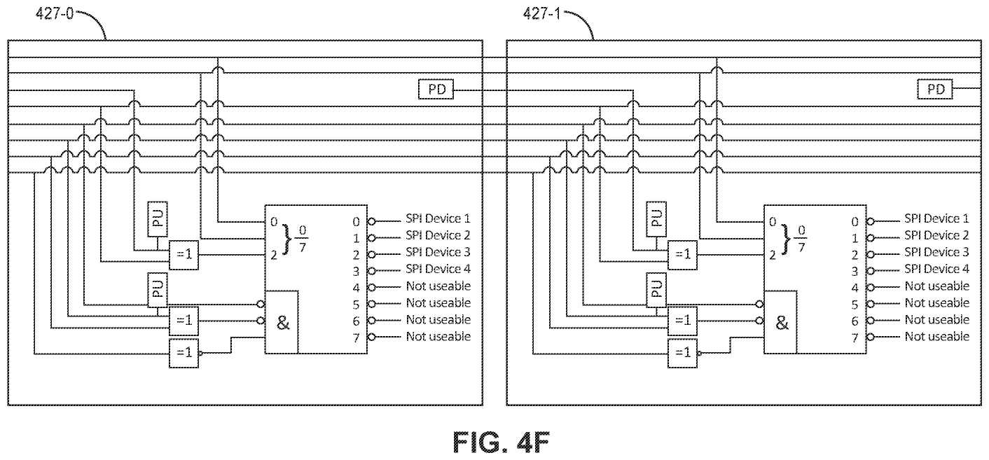

FIGS. 4A-4F are schematic diagrams illustrating exemplary control interfaces. For example, FIG. 4A illustrates the transmitting of control signals through a typical serial peripheral interface (SPI) 430A. As known to one having skill in the art, SPI devices typically communicate in full-duplex mode, where a controller device selects a device to receive communications. As shown, the interface 430A may have a controller 431A that communicates with n devices 433-0 through 433-n through the interface 430A. The devices 433-0 through 433-n may be referred to generally as device 433 and collectively as devices 433. Within an access point, the controller 431A may be an FPGA, processor, microcontroller, or other device on the BBC capable of sending control commands through an interface 430A. Further, the devices 433-0 through 433-n may be n devices located on a radio module, BBC, or power pallet connected to a radio module.

In some communication interfaces (SPI, inter-integrated circuit, RS485, etc.), the interfaces are used for communication at an inter-board or inter-component level. Thus, a device may be communicating with devices on the board and with devices on connected boards through the same interface, like interface 430A. To facilitate communications with multiple devices 433 through the interface 430A, the controller 431A may use addressing to ensure that the controller 431A communicates with a desired device 433. Within an SPI interface, chip-select lines may be used to address communications to the different devices 433.

As illustrated in the typical interface 430A, the controller 431A may send four separate logic signals to each of the devices 433. For example, the controller 431A may be connected to each of the devices 433 with a master-in-slave-out (MISO) line, a master-out-slave-in (MOSI) line, a clock-signal line, and separate chip-select lines. The controller 431A is coupled to the devices 433 through common MISO, MOSI, and clock signal lines. However, the controller 431A is separately coupled to each of the devices 433 with a respective chip-select line.

When transmitting control signals to one or more of the devices 433, the controller 431A may send a signal to the desired device 433 on the chip-select line that connects the controller 431A to the desired device. When a device 433 receives a signal on the connected chip-select line, the device 433 activates. An active device 433 receives signals on the clock signal line and the MOSI line. Also, the active device 433 transmits signals on the MISO line. However, when a device does not receive a signal on the connected chip-select line, the device 433 is deactivated. A deactivated device 433 disregards signals on the clock signal line and the MOSI line. Also, the deactivated device 433 does not drive signals on the MISO line.

In the typical interface 430A, each device 433 requires a dedicated chip-select line between the device 433 and the controller 431A. However, in the modular design of BBC and radio modules, the controller 431A may be connected to more controllable devices 433 than permitted through the typical SPI interface. Additionally, the number of devices 433 may change as components (like radio modules, DPEMs, power pallets, etc.) are installed within an access point such that controller 431A would need additional chip-select lines to control the additional devices.

In certain embodiments, a controller on a modular BCC may frequently control 10-20 devices through an SPI interface. In a typical SPI interface, such as the interface 430A, the controller 431A would have a dedicated pin for each potential device 433. Having 20 pins and 20 associated chip-select lines increases the complexity of the design. Thus, the SPI interface between the controller and the devices may include an x-to-y line decoder that reduces the number of pins and chip-select lines between a controller and connected devices.

FIG. 4B is a schematic diagram of an interface 430B that incorporates an x-to-y line decoder 435 to increase the number of supported devices while limiting the number of pins on a controller 431B. As known to one having skill in the art, an x-to-y line decoder 435 is a device that can identify y mutually exclusive outputs from a series of x binary weighted address inputs. In particular, the x-to-y line decoder 435 may receive a series of x binary signals, where each binary signal is either high or low. Based on the combination of signals, the x-to-y line decoder 435 identifies a decimal number within a range of y binary signals. For example, if the x-to-y line decoder 435 receives three binary signals, the x-to-y line decoder 435 may identify a number in the range of 0-7. The interface 430B may include an x-to-y line decoder 435 to reduce the number of pins dedicated to chip-select signals.

In certain embodiments, the controller 431B may send control and communication signals to a series of devices 433-0 through 433-7 through an interface 430B. The devices 433-0 through 433-7 are functionally similar to the devices 433 described above in FIG. 4A and are also referred to generically and generally as devices 433. Specifically, the devices 433 have four connections that include a MISO line, a MOSI line, a clock signal line, and a chip-select line. From the perspective of the devices 433, the interface 430B is substantially the same as the interface 430A. Also, the MISO line, MOSI line, and clock signal line are each coupled from respective pins on the controller 431B directly to each of the devices 433, as done in a typical SPI interface.

In additional embodiments, instead of sending different chip-select signals on different lines for each device 433, the controller 431B sends a single chip-select signal and a series of binary signals (for example, ADD0, ADD1, ADD2) to an x-to-y line decoder 435. The x-to-y line decoder 435 may be active when the chip-select signal is low, or, conversely, the x-to-y line decoder 435 may be active when the chip-select signal is high. Based on the series of binary signals, the x-to-y line decoder 435 transmits the chip-select signal to one of the devices 433. For example, the x-to-y line decoder 435 may receive three binary signals from the controller 431B. The controller 431B may set the binary signals to either low or high to identify one of the devices 433. Thus, if all three signals are low and the controller 431B sends a chip-select signal to the x-to-y line decoder 435, the x-to-y line decoder 435 will determine that the chip-select signal is for the device coupled to output 0 of the x-to-y line decoder 435 and couple the received chip-select signal through output 0 of the 435, which is coupled to the device 433-0. Upon receiving the chip-select signal, the device 433-0 begins to receive the MOSI and clock signals while transmitting through the MISO line.

As the controller 431B has three separate binary signals, the controller 431B can send eight different combinations of signals to the x-to-y line decoder 435. Based on the binary signals, the x-to-y line decoder 435 can couple the received chip-select signal to any one of the specified outputs. Accordingly, instead of having eight chip-select pins on the controller 431B, the controller 431B may include three separate binary signals pins and one chip-select pin. Thus, using the x-to-y line decoder 435 reduces the number of pins needed to communicate with a large number of devices. Additionally, using the x-to-y line decoder 435 allows for the auto-expansion of the interface 430B as new devices 433 can be added by merely coupling the device 433 to an available output pin on the x-to-y line decoder 435 and updating the controller to be aware of which pin on the x-to-y line decoder 435 is associated with the x-to-y line decoder 435.

FIG. 4C is a schematic diagram of an interface 430C that has multiple x-to-y line decoders. For example, the interface 430C has four x-to-y line decoders 435-0 through 435-3 (referred to generally as x-to-y line decoder 435 and collectively as x-to-y line decoders 435). Thus, the controller 431C may be able to control up to 32 different devices with significantly fewer than 32 pins that would be used in a typical SPI interface.

In certain embodiments, the controller 431C may be similar to the controller 431B, which is found in FIG. 4B with regards to providing a MISO, MOSI, clock signal, chip-select, and binary signal lines. Additionally, the controller 431C includes x-to-y line select lines (ADD3, ADD4) that allow the controller 431C to designate which x-to-y line decoder 435 is currently active. For example, with two x-to-y line select lines, the controller 431C may be able to select one of four possible x-to-y line decoders 435.

In additional embodiments, the x-to-y line decoders 435 are substantially the same as the x-to-y line decoders described above with respect to FIG. 4B. However, as there are multiple x-to-y line decoders, the x-to-y line decoders may include activating logic 437 coupled to the x-to-y line select lines and the chip-select line. An x-to-y line decoder 435 may become active as determined by an analysis by the activating logic 437 of signals received through the x-to-y line select lines and the chip-select line. In some implementations, the activating logic 437 may receive a chip-select signal and two x-to-y line select lines. The x-to-y line decoder 435 activates as determined by the activating logic 437 based on the signals received through the chip-select line and the x-to-y line select lines. For example (while not shown), the activating logic 437 may activate the x-to-y line decoder 435 by applying an XOR to the x-to-y line select lines. Thus, the activating logic 437 for each x-to-y line decoder 435 activates the associated x-to-y line decoder 435 when the signal on a first x-to-y line select line (ADD3) is low and the signal on a second x-to-y line select line (ADD4) is high. Additionally, some of the inputs of the x-to-y line select lines may pass through inverters 439 to diversify the received x-to-y line select signals such that when the controller 431C sends out x-to-y line select signals on the x-to-y line select lines, each x-to-y line decoder 435 may receive different signals due to the inverters 439.

In some exemplary implementations, when communicating with any of the x-to-y line decoders 435, the controller 431C may set the chip-select signal to low or high, which will be coupled into each of the activating logic 437 of each x-to-y line decoder 435, where the activating logic 437 will convert a low signal to a logic high. In addition to sending the chip-select signal to low (or high, based on the activating logic), the 431C also sets the x-to-y line select signal on the x-to-y line select lines to a specific configuration associated with a particular x-to-y line decoder. For example, the x-to-y line select lines, connected to the x-to-y line decoder 435-0, have no interceding inverters 439. Thus, if the controller 431C sends signals such that the signal on the first x-to-y line select line is low and the second x-to-y line select line is high, then the x-to-y line decoder 435-0 will receive the chip-select line, and the binary signals for selecting a device connected to the x-to-y line decoder 435-0.

In further examples, the x-to-y line select lines connected to the x-to-y line decoder 435-1 may have an interceding inverter 439 on the first x-to-y line select line. Thus, if the controller 431C sends signals such that both x-to-y line select lines are high, then the inverter 439 on the first x-to-y line select line will invert the high signal on the first x-to-y line select line to low such that the x-to-y line decoder 435-1 will receive the chip-select line, and the binary signal for selecting a device connected to the x-to-y line decoder 435-1. Additionally, the x-to-y line select lines connected to the x-to-y line decoder 435-2 may have an interceding inverter 439 on the second x-to-y line select line. Thus, if the controller 431C sends signals such that both x-to-y line select lines are low, then the inverter 439 on the second x-to-y line select line will invert the low signal on the second x-to-y line select line to high such that the x-to-y line decoder 435-2 will receive the chip-select line, and the binary signal for selecting a device connected to the x-to-y line decoder 435-2. Moreover, the x-to-y line select lines connected to the x-to-y line decoder 435-3 may have interceding inverters 439 on both the first and second x-to-y line select lines. Thus, if the controller 431C sends signals such that the signal on the first x-to-y line select line is high and the second x-to-y line select line is low, then the x-to-y line decoder 435-3 will receive the chip-select line, and the binary signals for selecting a device connected to the x-to-y line decoder 435-3.

Thus, by using the activation logic 437, the controller 431C may select an x-to-y line decoder 435 from a group of x-to-y line decoders 435 to expand the number of devices controllable by the controller 431C through the interface 430C. The activation logic can also further expand the number of devices controllable by the controller 431C using additional external logic elements with a third x-to-y line decoder select line or by using a decoder with four inputs as part of the activation logic.

FIG. 4D is a diagram illustrating an interface 430D having XOR gates 441 in place of the inverters 439, where the XOR gates 441 allow either the inversion or noninversion of digital signals depending on the second input of the XOR. Thus, the use of two x-to-y line select lines can function as an address for the x-to-y line decoders 435. Certain input lines are pulled high or to ground using resistors such that the x-to-y line decoders 435 are associated with fewer devices, but a controller 431C can control more x-to-y line decoders. For example, the XOR gate 441 may provide connector-dependent addressing for an SPI. Adding also an input of the x-to-y line decoder to the XOR gate 441 may enable the controller 431C to connect to eight modules, which are in turn connected to four SPI devices.

FIG. 4E is a diagram illustrating a system 432 that implements self-addressing SPI interfaces (such as an interface having the XOR gates 441 described in FIG. 4D), such that a BBC 413 can control multiple connected and cascaded modules. In some implementations, the BBC 413 may connect to an SPI interface device 428 that is similar to the SPI interface described in FIG. 4C. However, half of the addressable devices by the BBC 413 are addressed to devices connected through a PDDB 443. For example, the BBC 413 may provide the x-to-y line decoder select lines through the PDDB 443 to multiple power pallets 427-0-427-3.

In certain embodiments, the PDDB 443 may include different connections that connect to a self-addressing SPI interface on a power pallet 427 such that the BBC 413 is able to select separate groups of cascaded power pallets 427 within multiple groups of cascaded power pallets 427, where the different power pallets 427 have the same configuration. For example, directly connected power pallets (427-0 and 427-2) may couple the highest chip select line tied to open by the PDDB 443. Further, the chip select lines extend through each of the power pallets 427 to cascaded power pallets. However, in contrast to the PDDB 443, a power pallet 427 ties the highest chip select line of cascaded power pallets (427-1 and 427-3) to ground. Thus, the interfaces allow for the selection of multiple cascaded power pallets 427. Thus, the BBC 413 can control the activation of the different groups of power pallets 427.

In further embodiments, the power pallets can be cascaded from one another. For example, the power pallet 427-1 may be coupled to the power pallet 427-0 in a first group of power pallets, and the power pallet 427-3 may be coupled to the power pallet 427-2 in a second group of power pallets. The cascaded power pallets 427-1 and 427-3 may connect to the respective power pallets 427-0 and 427-2 in a similar manner, such that the BBC 413 can select different address groups for each of the power pallets. For example, both power pallets 427 within a power pallet group may receive the same activation signals from the BBC 413 through the PDDB 443. In particular, the highest-order bit of the three addressing bits is connected to an XOR gate. The PDDB 443 provides a ground signal to the power pallets 427 that are directly connected to the PDDB 443, which is an input along with the addressing signal from the BBC 413 to the XOR gate on the highest addressing bit. As such, the highest addressing bit for the power pallets 427 that are directly connected to the PDDB 443 (power pallets 427-0 and 427-2) are tied to low. In contrast, an XOR gate on the highest order bit for a cascaded power pallet 427 (such as power pallets 427-1 and 427-3) may receive a high signal from the interceding power pallet 427 in connection with the highest order addressing signal from the BBC 413. Thus, when the highest order bit signal from the BBC 413 is low, the cascaded power pallets 427-1 and 427-3 will have addresses 0-3 selected, whereas the directly connected power pallets 427-0 and 427-2 will have addresses 0-3 selected when the highest order bit signal is high. Accordingly, the BBC 413 may use self-addressing connections provided by the SPI interfaces to control devices connected to the different power pallets.

FIG. 4F is a diagram illustrating two cascaded power pallets 427-0 and 427-1. As illustrated, the power pallets 427 may be fabricated to have the same circuit configuration. For example, when a power pallet 427 is connected to the BBC 413 or the PDDB 443, devices can be connected to the SPI interface of the power pallet 427 through addresses 0-3. When a power pallet 427 is connected to another power pallet, devices can be connected to the SPI interface of the power pallet 427 through addresses 4-7.

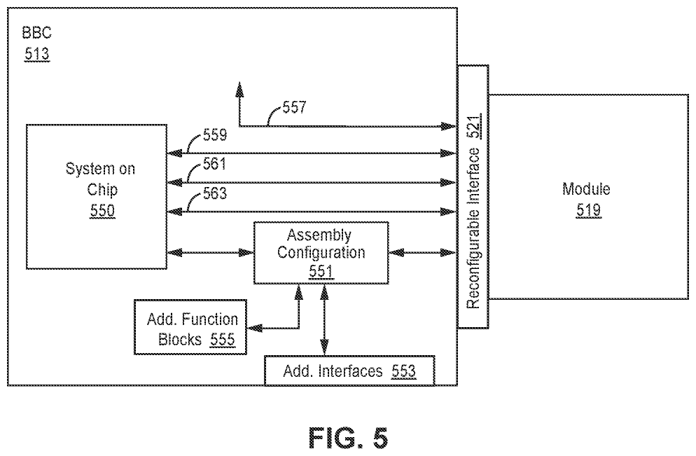

FIG. 5 is a block diagram of a reconfigurable interface between a BBC 513 and a module 519. As discussed, the BBC 513 may function in a similar manner to the BBC 213 in FIG. 2. As discussed above, a BBC 213 may have multiple interfaces 221 that can function as an interface between different types of radio modules, power pallets, data and power entry modules (DPEMs), radio modules that are connected to power pallets, and the like. To connect to the various modules, the interfaces may be realized with different standards or proprietary hardware. To be able to connect through the different interfaces, the BBC 213, 513 may include one or more reconfigurable interfaces 521.

In certain embodiments, a reconfigurable interface 521 may be an interface having a combination of pins with dedicated fixed functionalities and pins that are reconfigurable to perform multiple functions. Accordingly, a reconfigurable interface 521 may be able to connect to modules with different functionalities and different applications. For example, a reconfigurable interface 521 may be able to support connections to radio modules, DPEMs, and other potential modules. As stated above, a radio module is a module that can have various interface configurations. For example, the radio module may include a digital interface and an RF interface, a digital interface and an IF interface, an IF interface and an RF interface, or two RF interfaces. The radio module may amplify RF signals, convert and amplify baseband signals, convert IF signals, or convert and amplify IF signals. Additionally, a DPEM may be a module for the distribution of signals between the BBC 513, internal modules of an access point, and external modules connected to the access point. The reconfigurable interface 521 can be reconfigured to support connections to various types of modules.

In exemplary embodiments, a reconfigurable interface 521 may be reconfigured through different reconfiguration methods and devices. For example, the reconfigurable interface 521 may be reconfigured by hardware, software, FPGA, and the like. In some implementations, the pins of the reconfigurable interface 521 may be grouped by their reconfigurability and method for reconfiguration. For example, the pins of the reconfigurable interface 521 may include fixed hardware pins 557, fixed FPGA/software pins 559, software-reconfigurable pins 561, FPGA reconfigurable pins 563, and assembly configurable pins 551.

In certain embodiments, to enable reconfiguration, some of the pins of the reconfigurable interface 521 may be connected to a system on chip (SOC) 550. As described herein, the SOC 550 may refer to a series of FPGAs and/or processors that execute software based on signals received through the reconfigurable interface 521 and other signal sources. As shown, the SOC 550 may receive a combination of signals from different portions of the reconfigurable interface 521. For example, the SOC 550 may receive signals on fixed FPGA/software pins 559. The fixed FPGA/software pins 559 may provide for the exchange of signals between the reconfigurable interface 521 and the SOC 550, where the signals are used by the executing software and FPGA on the SOC 550 in the same manner regardless of the module 519 connected to the reconfigurable interface 521. Similarly, the fixed hardware pins 557 may fixedly connect to other components on the BBC 513 independent of what module 519 is connected to the reconfigurable interface 521.

As stated, the BBC 513 includes several different systems for reconfiguring the reconfigurable interface 521 that vary in the accessibility for performing the reconfigurations. For example, the BBC 513 may include the assembly configurable pins 551. The assembly configurable pins 551 may be used to reconfigure the functionality of the connected pins. Reconfiguration of the assembly configurable pins 551 may reroute signals received through the pins to additional interfaces 553 or additional function blocks 555 on the BBC 513. As part of the assembly configurable pins 551, the pins of the reconfigurable interface 521 may be connected to a reconfigurable assembly block, where the assembly options can be changed to reroute the received signals along different signal paths like towards different functional blocks in the additional function blocks 555 and different interfaces in the additional interfaces 553.

In an additional embodiment, the software reconfigurable pins 561 may include pins of the reconfigurable interface 521 that are connected to a processor within the SOC 550. The processor within the SOC 550 may process the signals received and transmit signals through the 561 based on the software that is executed by the processor within the SOC 550. Thus, changing the software executed by the processor may reconfigure the functionality associated with the software reconfigurable pins 561.

In further embodiments, the FPGA reconfigurable pins 563 may include pins of the reconfigurable interface 521 that are connected to an FPGA within the SOC 550. The FPGA within the SOC 550 may perform different functions using the signals received and transmitted through the FPGA reconfigurable pins 563 based on the current FPGA configuration. Thus, flashing the FPGA with a new configuration may reconfigure the functionality associated with the FPGA reconfigurable pins 563.

In some embodiments, the communication frequency standard being used may call for a higher bandwidth on a DAS or repeater system. Additionally, power-efficient systems are increasingly desired. In some systems, many signal processing steps are performed in the FPGA within the SOC 550. These signal processing steps may include serializing, de-serializing, filtering, data-rate conversion, among other processing steps. When the FPGA performs all of the signal processing steps, the signal processing may consume many of the limited FPGAs resources, which limits the bandwidth of the FPGA. Additionally, FPGAs are not as efficient in terms of power consumption as compared to other potential implementations, such as the power consumption of application-specific integrated circuits.

In certain embodiments, the module 519 may include one or more transceiver chips that also have integrated signal processing capabilities. For example, a transceiver chip may be capable of performing digital-up-conversion/digital-down-conversion (DUC/DDC), IQ compression/de-compression, fast Fourier transformation/inverse fast Fourier transformation (FFT/IFFT), CP (cyclic prefix) PRACH, filtering and antenna calibration, crest factor reduction (CFR), digital pre-distortion (DPD), interpolation and decimation, among other processing capabilities. Because of the signal processing capabilities of the transceiver chips on the module 519, the FPGA within the SOC 550 may outsource some of the signal processing through the reconfigurable interface 521. By outsourcing the signal processing, the FPGA resources can be free to support increased bandwidth. Additionally, the transceiver chips are frequently ASICs that operate more efficiently than FPGAs. Thus, by outsourcing the signal processing to transceiver chips on the module 519, a system can operate with increased bandwidth or lower power. If the same resources are allocated, the power consumption may stay the same, but the bandwidth is increased. However, if the freed-up resources are not used, the power consumption is reduced.

In additional embodiments, a module 519 may connect to the reconfigurable interface 521 using multiple technologies. For example, the module 519 may connect to the reconfigurable interface 521 using a standard edge card connector system. Alternatively, the module 519 may connect to the reconfigurable interface 521 using a customizable system of different technologies to form a proprietary interface. For example, different connective technologies may be selected based on the electrical parameters of the reconfigurable interface 521 and the module 519, mechanical circumstances, economic considerations, and the like.

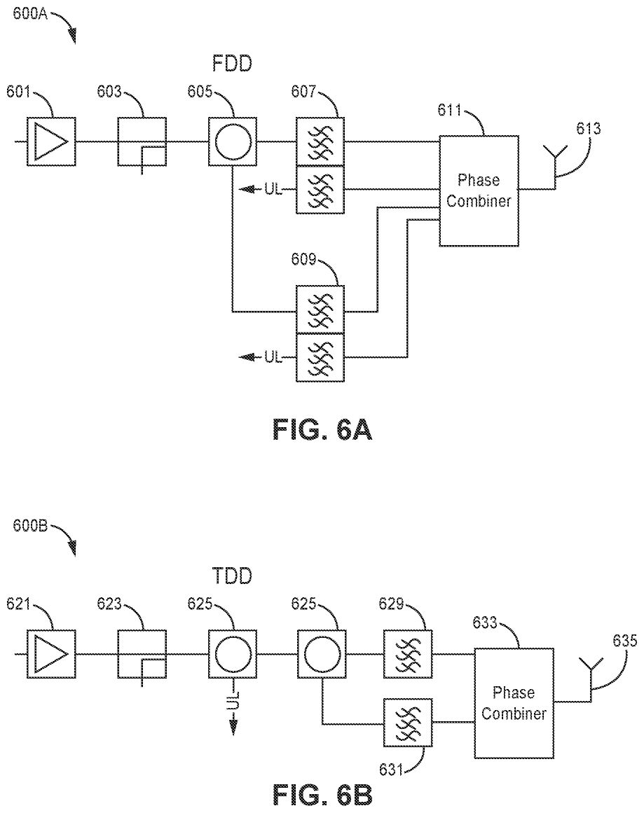

In certain embodiments, the modules 519 may be radio modules that have multiband amplifiers that reflectively combine signals for multiband applications. For example, FIG. 6A is a block diagram of an FDD system 600A that uses reflective combining to combine signals from two filters or duplexers. FIG. 6B is a block diagram of a TDD system 600B that uses reflective combining to combine signals from two filters or duplexers.

With respect to FIG. 6A, the FDD system 600A may include a multiband amplifier 601 that amplifies a received downlink signal. For example, the multiband amplifier 601 may amplify signals over a frequency range and provide the amplified downlink signal to a coupler 603. The coupler 603 couples a portion of the amplified downlink signal for digital pre-distortion (DPD) and couples another portion of the amplified downlink signal to a circulator 605 that, in combination with filters 607 and 609, reflectively splits the received amplified downlink signal for filtering and subsequent phase combining by the phase combiner 611, which combines the filtered signals for transmission through an antenna 613.

In the uplink direction, the FDD system 600A may receive a signal from user equipment through the antenna 613 and couple the received signal into the phase combiner 611. The phase combiner 611 splits the signals into each of the filters 607 and 609 for filtering the received signal. As shown, the filters 607 and 609 have different passbands for the uplink and downlink direction to support FDD. After filtering the received signals, the filters 607 and 609 may couple the filtered uplink signals onto an uplink path.

In the downlink direction, the multiband amplifier 601 may receive a signal for transmission to user equipment. The multiband amplifier 601 may provide the amplified signal to a coupler 603, where the coupler 603 couples the amplified signal to a DPD circuit to improve linearity. The signal is then coupled into the circulator 605. The circulator 605 may circulate the signal either clockwise or counterclockwise. For the sake of explanation, assuming the circulator 605 rotates clockwise, the circulator 605 may couple the signal from the received signal from the coupler 603 into the filter 607. The filter 607 may filter a first portion of the received signal and reflect a second portion of the received signal. The filter 607 may then provide the filtered first portion to the phase combiner 611. The reflected second portion from the filter 607 is coupled back into the circulator 605, where the circulator 605 then couples the reflected second portion to the filter 609, which then filters the second portion of the signal and provides the filtered second portion to the phase combiner 611 that combines the filtered second portion with the filtered first portion for transmission through the antenna 613 to user equipment.

In an exemplary implementation, the passband of the filter 607 may have a passband of 1805-1880 MHz, and the passband of the filter 609 may have a passband of 2110-2170 MHz. The signal received by the circulator 605 may have signal components in both the passbands of the filter 607 and 609. The filter 607 may have a good return loss and low insertion loss for the passband 1805-1880 MHz. However, for the frequency range 2110-2170 MHz, the filter 607 may show bad return loss and high insertion loss, so the filter 607 will reflect the signal components in the 2110-2170 MHz frequency range back to the circulator 605. The circulator 605 will then couple the reflected signal to the filter 609, which has good return loss and low insertion loss for signals in the passband 2110-2170 MHz.

In additional embodiments, the FDD system 600A may include an additional isolator in high-power applications. The isolator may reduce the reflected power of the DPD signal to improve DPD cancellation when reflectively combining signals.

With respect to FIG. 6B, the TDD system 600B may include a multiband amplifier 621 that amplifies a received downlink signal and receives uplink signals. For example, the multiband amplifier 621 may amplify signals over a frequency range and provide the amplified downlink signals to a coupler 623. The coupler 623 couples a portion of the amplified downlink signals for digital pre-distortion (DPD) and couples another portion of the amplified downlink signal to a circulator 627 through circulator 625. The circulator 625 acts as the combining/splitting point for signals in the downlink and uplink direction. The circulator 627 splits the amplified downlink signals reflectively and couples the signals into the filters 629 and 631, which have different passbands similar to the reflective splitting described above with respect to FIG. 6A. After filtering the signals, the filters 629 and 631 may couple the filtered signals to a phase combiner 633, which combines the filtered signals for transmission through an antenna 635 for reception by user equipment within the coverage area of the 635.

In the uplink direction, the TDD system 600B may receive a signal from user equipment through the antenna 635 and couple the received signal into the phase combiner 633. The phase combiner 633 provides the received signals to each of the filters 629 and 631 for filtering, where the received signal has at least two different frequency components. As discussed above with respect to filters 607 and 609 in FIG. 6A, the filters 629 and 631 may have different passbands. As such, the filter 629 may filter the received signal having the first and second frequency components and pass the first frequency component, and the filter 631 may also filter the received signal and pass the second frequency component. The filters 629 and 631 then provide the passed frequency components to the circulator 627, which may circulate received signals in a clockwise direction. Thus, the circulator 627 provides the passed frequency component from the filter 631 to the circulator 625, and the passed frequency component from the filter 629 to the filter 631. As the passed frequency component from the filter 629 is outside of the passband of the filter 631, the filter 631 will reflect the passed frequency component from the filter 629 back to the circulator 627. The circulator 627 then circulates the reflected signal for coupling to the circulator 625. Signals provided to the circulator 625 from the circulator 627 are coupled onto an uplink path for additional processing.

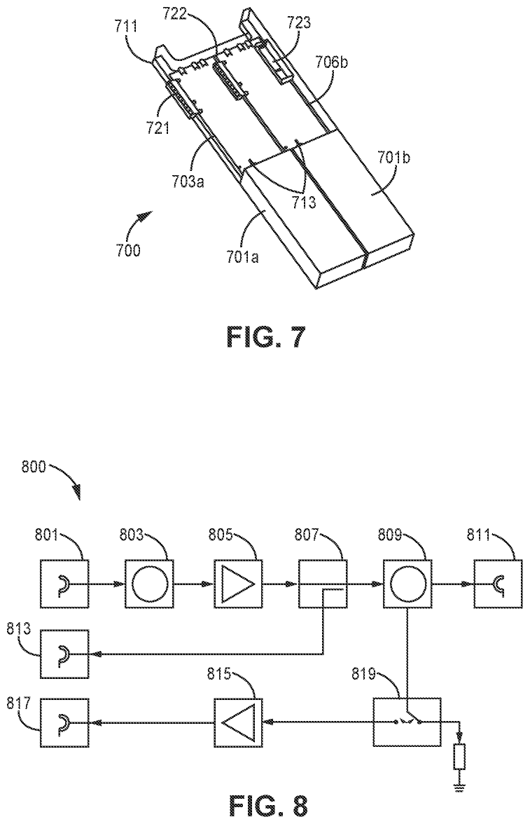

FIG. 7 is an isometric view of a system 700 having two high power pallets 703a and 703b, having active duplexers 701a and 701b, that can be modularly integrated with one or more power pallets within a single housing. As used herein, high-power pallets 703 are devices having a high-power amplification stage for use within a high-power access point. In some implementations, the system 700 may include two cascaded power pallets 703a and 703b, where each power pallet 703 may be associated with a different frequency band or coverage area. As illustrated, the power pallets 703 are electrically connected to each other and mounted on a common frame 711. The frame 711 may be made from a thermally conductive material to facilitate cooling of the power amplification of the power pallets 703. Alternatively, the power pallets 703 can each have their own housing, which are mounted to each other.

Using the power pallets 703 coupled to lower-power radio modules permits the modular design of power lineups of transistors associated with each power class. In particular, radio modules of lesser power classes may be used as driver stages for radio modules of greater power classes. For example, a low-power radio module may function as an amplification driver stage for a medium-power radio module. Also, in a high-power lineup, a power pallet 703 may be coupled to a medium-power radio module, where the medium-power radio module functions as an amplification driver stage for the power pallet 703. Also, the medium-power radio module acting as a driver stage, may be coupled to a low-power radio module that functions as a pre-driver stage. The BBC may control the power lineups of the various power classes. For example, the BBC may communicate with the different devices in the power lineup using the SPI interface described above.

In certain embodiments, a power pallet 703 may include one or more interfaces 721 and 723. The interface 721 may provide a connection to a controlling BBC, a PDDB, or to a driving radio module. Additionally, an additional interface 723 allows the power pallet 703 to be coupled to a similar interface 721, through coupled interfaces 722, on an additional power pallet 703. For example, one power pallet 703a receives control signals and signals for amplification from the BBC, either directly or through an intermediating driver stage (like an intermediate radio module). Some of the signals may be intended for the additional power pallet 703b. Thus, the power pallet 703a that first receives the signals from the BBC may pass some of the signals to the additional power pallet 703b. Additionally, the power pallet 703a that initially receives signals for the BBC through the interface 721 may include circuitry for addressing the additional power pallet 703b, as described in FIG. 4E. In some implementations, all signals received through the interface 721 that first received the signals from the BBC are passed to all of the power pallets 703 within the system 700. However, using the functionality described above concerning the SPI interface 430 of FIGS. 4D-4F, only the intended power pallet 703 may act on the received signals.

In some implementations, when the power pallet 703 connects to a BBC, PDDB, or to a radio module, the interface 721 of one of the power pallets 703 may couple to the connected device such that the power pallet 703 is arranged perpendicularly in relation to the connected device. Thus, in exemplary embodiments, an edge connector may connect to modules that are arranged in-line (180°) or perpendicularly (90°) with respect to the connected device. Also, the edge connectors may capably connect to cards in different orientations while consuming the same footprint as a connector that connects to a card in a single orientation. Additionally, the edge connectors may also connect to cards in orientations other than 90° and 180°. By using connectors that allow connecting cards in multiple orientations, the cards can be connected to each other within an access point having any of multiple form factors. Additionally, the cards can be connected to each other in a flat arrangement to facilitate passive cooling or in a compact manner to facilitate active cooling.

As illustrated in FIG. 7, the power pallets 703 may also be coupled to one or more duplexers 701 that are coupled to the output of associated power pallets 703. The duplexers 701 receive the RF output from the associated power pallets 703 and provide RF signals to the associated power pallets 703. The duplexers can implement frequency-selective filters. In some implementations, a duplexer 701 may be connected to the power amplifier using a soldered or other type of direct connection 713. Using a direct connection 713 (like a fixed solder connection) can improve the power efficiency of the power pallet 703 for each power amplifier independent of the efficiency of the power transistor.

FIG. 8 is a block diagram of the components of a TDD power pallet 800. While the power pallet 703 may incorporate integrated duplexers, in some embodiments, the power pallet 800 may include amplification stages without integrated duplexers.

In some embodiments, the power pallet 800 receives downlink signals from a downlink signal source through a downlink contact 801. The downlink signal source may be a BBC, a medium-power radio module, or a lower-power radio module acting as a driver stage. When the power pallet 800 receives the downlink signal, the circulator 803 receives the downlink signal and provides the received downlink signal to the amplifier 805. The amplifier 805 may amplify the downlink signal to a desired output power for transmission through antennas in the coverage area associated with the access point. Additionally, the amplifier 805 is coupled to a coupler 807. The coupler 807 couples a portion of the amplified signal into a DPD path 813. In some embodiments, the DPD path 813 is provided to circuitry or processing DPD is calculated and applied within the power pallet 800. Alternatively, the DPD path 813 may couple the amplified signal to another device, such as circuitry/processing found on the medium power or lower power driving stage or on the BBC. Also, the DPD path 813 may function as a feedback path in a switched automatic level control (ALC) or as a feedback path for other uses. Additionally, the coupler 807 transmits another portion of the amplified signal to another circulator 809 that circulates the amplified signal to a contact 811. The contact 811 couples the output stage to another amplification stage or to a duplexer for transmission to user equipment within a coverage area.

In the uplink direction, the power pallet 800 may receive an uplink signal that originated from user equipment within the coverage area through the contact 811. The contact 811 couples the received uplink signal to the circulator 809. The circulator 809 couples the uplink signal to an isolation switch 819 that isolates the amplifier 815 from receiving signals at power levels that could potentially destroy the amplifier 815, such as signals received when in the TX mode. When receiving uplink signals from the circulator 809, the switch 819 may transmit the uplink signals to the amplifier 815. The amplifier 815 may amplify the received signal and provide the received signal to another component within the access point (such as a connected BBC, medium power, or lower power driver stage) through an uplink contact 817.

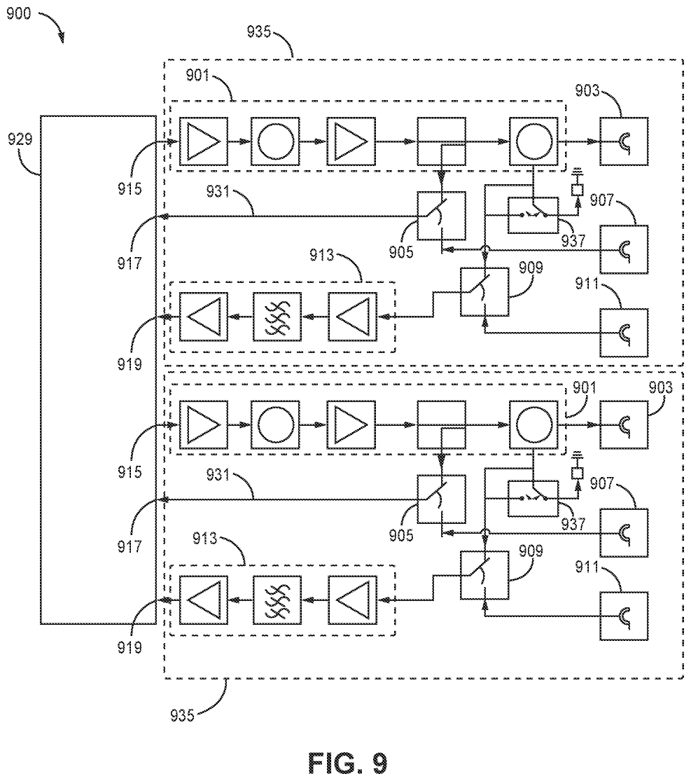

FIG. 9 is a schematic diagram illustrating a DPD switch within a radio module 900 that is able to switch between different receive DPD feedback paths. For example, a linearizer module may function over the different connected stages within a power lineup to facilitate DPD that corrects the nonlinearities that arise along the power lineup over a wide bandwidth. For example, a DPD feedback path can be adapted for the various power classes. In some implementations, where a lower power class module is used as a driver stage for a higher power class module, a DPD observation path of the higher power class module may be coupled to a path in the lower power class module. The lower power class module may include a switch for switching between observing the distortion caused by the amplification in the module with the switch or from amplification in the higher power class module. For example, a high-power pallet may couple to an observation path within a medium-power radio module, where a switch within the medium-power radio module switches to receive signals from the observation path of the high-power pallet.

For example, the radio module 900 may include multiple uplink/downlink paths 935. For example, the radio module 900 includes two uplink/downlink paths 935. Each of the uplink/downlink paths 935 may couple to additional radio modules of a higher power class through multiple contacts. The uplink/downlink paths 935 may also be coupled to a module 929 through multiple contacts, where the module 929 may be a BBC, PDDB, medium-power class module, or a lower-power class module. The module 929 may further include functionality to calculate and apply predistortion to linearize the amplification of the downlink signals.

In some embodiments, the uplink/downlink paths 935 having switches 905 and 909 may support multiple configurations that include at least a medium-power TDD, a medium-power FDD, a high-power TDD, and a high-power FDD. For example, when supporting a medium-power TDD, the downlink circuitry 901 may provide a transmit signal that is coupled to an input/output 903 that may be connected to an antenna or a combiner. Additionally, the radio module 900 may couple a received signal, coming from the input/output 903, to the receive select switch 909 through an isolation switch 937, which couples the received signal to the uplink circuitry 913. Additionally, a DPD feedback select switch 905 is switched to receive a signal from a coupler in the downlink circuitry 901.

Further, when supporting a medium power FDD, the transmit signal from the downlink circuitry 901 is coupled to the input/output 903, which is connected to a duplexer. The radio module 900 may receive a signal coming from a different port of the duplexer connected to the receive input port 911, which couples the received signal to the receive select switch 909. The receive select switch 909 couples the signals received from the input port 911 into the uplink circuitry 913. The DPD feedback select switch 905 is also switched to receive a signal from a coupler in the downlink circuitry 901.

Additionally, when supporting a high-power TDD, the transmit signal from the downlink circuitry 901 is coupled to the input/output 903, which is connected to a high-power pallet. The radio module 900 receives a signal from the high-power pallet through a connection to the input port 911, which couples the received signal to the receive select switch 909. Further, the radio module 900 may receive a feedback signal from the high-power pallet through an input 907, which is coupled to a DPD feedback select switch 905. The DPD select switch 905 couples the feedback to the DPD feedback path 931. Moreover, when supporting high-power FDD, the radio module 900 operates in a similar manner as when supporting high-power TDD.

In certain embodiments, each of the uplink/downlink paths 935 may include downlink circuitry 901. The downlink circuitry may function similarly to the downlink path described in FIG. 8. The downlink circuitry 901 may receive a signal from the module 929 through a downlink input 915 and may mix the downlink signal to a carrier frequency and amplify the signal. The signal may also be mixed in a connected power pallet for frequencies in the mmW range. After amplifying the signal, the downlink circuitry 901 may couple the signal into a downlink output 903 for coupling into a higher power class module or provide the signal to an antenna for transmission into a coverage area. The downlink circuitry 901 may also couple a portion of an amplified signal into a DPD switch 905. The DPD switch may couple the amplified signal into a DPD feedback path that couples to a feedback output 917 when providing the amplified signal produced by the downlink circuitry 901 to the module 929.

In additional embodiments, the uplink/downlink paths 935 may include uplink circuitry 913 that functions substantially as described above. The uplink circuitry 913 may receive signals from an uplink source through an uplink input port 911. The uplink input port 911 may be coupled to a higher power class module or may receive a signal through an antenna from user equipment. In some implementations, the uplink signal may pass through a switch 909, which statically couples the received uplink signal onto the uplink circuitry 913. The uplink circuitry 913 then provides the uplink signal through an uplink output 919 to a module 929 for further processing.

In some implementations, the DPD switch 905 may switch from providing the amplified signal produced by the downlink circuitry 901 or from receiving an amplified downlink signal from a connected higher power class module. For example, when a higher power class module is connected to the radio module 900, the higher power class module may couple the amplified downlink signal along a DPD feedback path for coupling into the radio module 900. The radio module 900 may receive the amplified downlink signal through the DPD feedback input 907. When the radio module 900 receives the DPD feedback through the DPD feedback input 907, the DPD switch 905 may switch to couple the DPD feedback input 907 along a DPD feedback path 931 into a DPD output 917. The module 929 may then receive the amplified downlink signal from the higher power class module to calculate the digital predistortion that is applied to the signal provided to the downlink input 915 by the module. As the amplified downlink signal from the higher-power class module is affected by the non-linear performance of the amplification by both the downlink circuitry 901 and the higher-power class module, the module 929 may calculate DPD to account for the non-linear performance of the amplification along the downlink signal path. Thus, the DPD switch 905 may provide DPD feedback for the radio modules connected to the module 929, whether the radio modules include multiple driver stages or a single driver stage. This modularity may enable the simplification of design complexity and cost reduction as well as better cooling of the final stage.

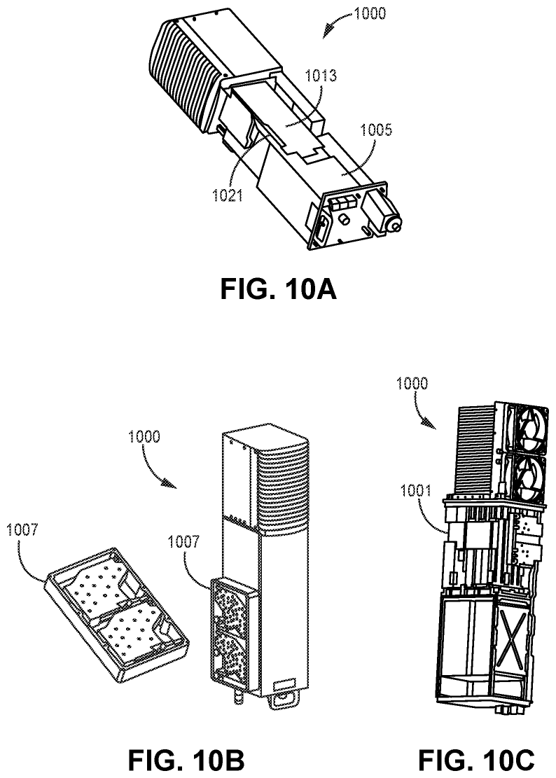

FIG. 10A is a diagram showing an embodiment of a high-power access point 1000 showing a DPEM 1005 connecting to an interface 1021 on a BBC 1013. As illustrated, the interface 1021 may be a connector that can connect to different modules that serve different purposes. For example, the interface 1021 may be reconfigurable such that the BBC 1013 can connect to either a DPEM 1005 or a radio module through the interface 1021. With respect to the DPEM 1005, the DPEM 1005 may extend in the same plane as the BBC 1013 as compared to connecting perpendicularly as may occur in other access points.

FIG. 10B is a diagram illustrating the placement of a filter cavity 1007 on a high-power access point 1000. In a high-power access point 1000, a filter cavity 1007 of a duplexer may be relatively large when compared to the other components within the access point 1000. Accordingly, the filter cavity 1007 may be mounted to an external surface of the high-power access point 1000. In some embodiments, the high-power access point 1000 may be placed such that additional space may exist between the high-power access point 1000 and neighboring structures. By mounting the filter cavity 1007 on the external surface, the additional space between the high-power access point 1000 and the neighboring structures may be used efficiently without having to increase the installation volume of the high-power access point 1000. Further, as the filter cavity 1007 is located on the external surface of the high-power access point 1000 and made primarily of thermally conductive material, the filter cavity 1007 may also be used to draw heat from inside the high-power access point 1000 for convective radiation into the environment of the high-power access point 1000.

FIG. 10C is a diagram illustrating the placement of a PDDB 1001 on a high power access point 1000. In the high-power access point 1000, the PDDB 1001 may receive signals from a BBC, power sources, radio modules, or other components and distribute the received signals to other components, such as to connected power pallets. As described above, the PDDB 1001 may include self-addressing circuitry as described above with respect to FIG. 4E.

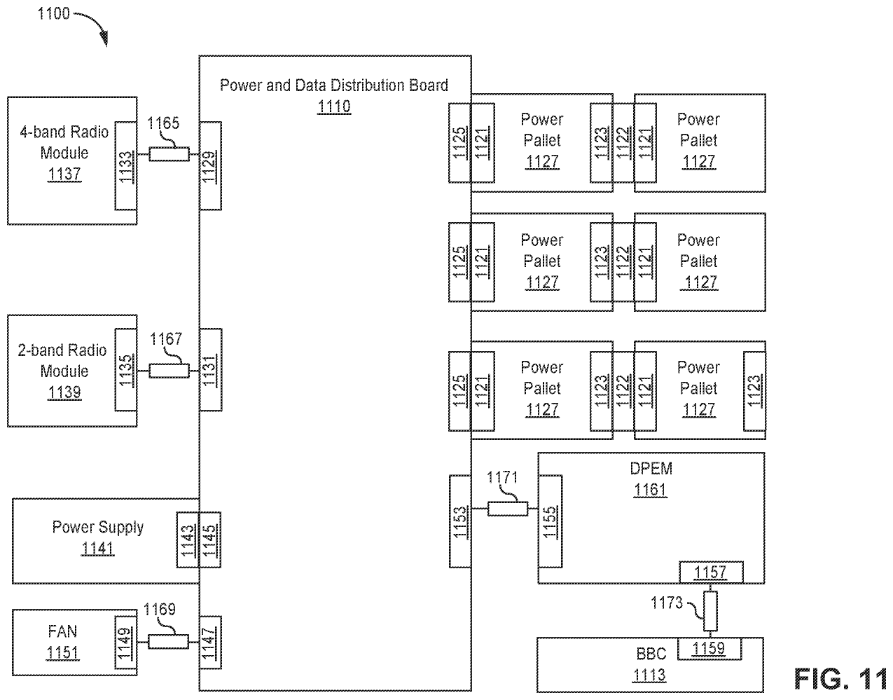

FIG. 11 is an exemplary block diagram of multiple modular components connected through a power and data distribution board 1110 within an access point 1100. The power and data distribution board 1110 may be similar to the PDDB 1001 in FIG. 10C or the PDDB 443, as shown in FIG. 4E. As illustrated, the access point 1100 may include a BBC 1113. As illustrated, the BBC 1113 may include an interface 1159 that connects to an interface 1157 on a DPEM 1161 through a bus 1173 or other connection type. The DPEM 1161 also includes an interface 1155 that couples to an interface 1153 through a bus 1171 or other connection type. Accordingly, the BBC 1113 may connect to the power and data distribution board 1110 through the DPEM 1161. Alternatively, the BBC may connect directly to the power and data distribution board 1110.

In additional embodiments, the power and data distribution board 1110 may include multiple interfaces 1125 for coupling to different power pallets 1127. The interfaces 1125 on the power and data distribution board 1110 may be similar to the SPI interfaces described in FIG. 4E. Accordingly, the power and data distribution board 1110 may include self-addressing circuitry for connecting to interfaces 1121 on the power pallets 1127. The interfaces 1121 may be similar to the interfaces 721 described in FIG. 7. Additionally, a power pallet 1127 may include an output interface 1123 for connecting to additional interfaces 1121 through a cascaded connection 1122, the interfaces 1123 and 1121 and the cascaded connection 1122 connecting the interfaces 1123 and 1121 are described above in connection with FIGS. 4E and 4F. Accordingly, the interfaces 1123 may also include self-addressing circuitry to facilitate the cascading of multiple similar power pallets 1127.

In a further exemplary embodiment, the power and data distribution board 1110 may include interfaces for connecting to different radio modules. For example, the power and data distribution board 1110 may include an interface 1129 and an interface 1131 for respectively connecting to a 4-band radio module 1137 and a 2-band radio module 1139. In particular, the interface 1129 may connect to an interface 1133 on the 4-band radio module 1137 through a connection 1165, and the interface 1131 may connect to an interface 1135 on the 2-band radio module 1139 through a connection 1167.

In some exemplary embodiments, the power and data distribution board 1110 may include an interface 1145 that couples to an interface 1143 on a power supply 1141. The power and distribution board 1110 may receive power from the power supply 1141 and distribute the power to the different components connected to the power and data distribution board 1110. Also, the power and data distribution board 1110 may include an interface 1147 that couples to an interface 1149 on a cooling fan 1151 through a connection 1169. The operation and powering of the fan may be controlled through signals received from the interface 1149.

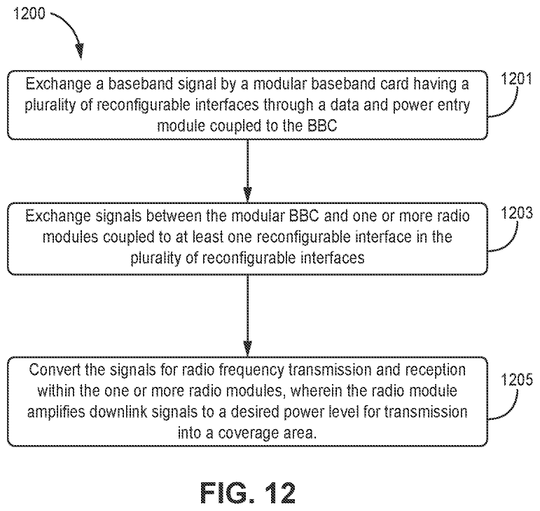

FIG. 12 depicts a flow diagram illustrating an exemplary method 1200 for operating an access point with modular components. The method 1200 may be implemented via the techniques and using the apparatus described with respect to FIGS. 1-12 but may be implemented using other techniques known to one having skill in the art. The blocks of the flow diagram have been arranged in a generally sequential manner to facilitate explanation. But, the arrangement of the blocks is merely exemplary, and the blocks can be arranged in any manner sufficient to provide the functionality described above with respect to FIGS. 1-12. For example, a processor may perform steps in different orders, in parallel, or as shown.

In exemplary embodiments, the illustrated method 1200 proceeds at 1201, where a baseband signal is exchanged by a modular baseband card having a plurality of reconfigurable interfaces through a data and power entry module coupled to the BBC. Also, the method proceeds at 1203, where signals are exchanged between the modular BBC and one or more radio modules coupled to at least one reconfigurable interface in the plurality of reconfigurable interfaces. Further, the method proceeds at 1205, where the signals are converted for radio frequency transmission and reception within the one or more radio modules, wherein the radio module amplifies downlink signals to a desired power level for transmission into a coverage area.

In embodiments described herein, processors (for example, processing units and FPGAs that function as part of the SOC 550 in FIG. 5 and transceiver chips found on the radio modules) are described as performing various tasks. Additionally, memory devices on the various modular components may store instructions and data, where the instructions stored on some of the memory devices instruct the one or more processors to perform the various tasks described herein using the data stored on the memory devices for operating access points. The one or more processors may be implemented using software, firmware, hardware, or other appropriate combinations thereof. The processors and/or additional computing devices may be supplemented by, or incorporated in, specially designed application-specific integrated circuits (ASICs) or FPGAs. The processors may be a general or special purpose computers or processors or other programmable logic devices. The processor and other computing devices may also include or function with software programs, firmware, or other computer-readable instructions for carrying out various process tasks, calculations, and control functions used in the present methods and systems.

Further, computer-executable instructions (such as program modules or components) may implement the methods described in this description. Software, firmware, or other execution-capable devices may execute the computer-readable instructions for carrying out various process tasks, calculations, and generation of data used in the operations of the described methods. The computer-readable instructions may be stored as part of one or more appropriate computer-program products, where a computer-program product may be a set of computer-readable instructions or data structures stored on a computer-readable medium. The computer-readable medium may be a media that stores data that the processor or other computing device can access. In certain implementations, the computer-readable medium may form part of a memory unit.

Computer-readable mediums may include non-volatile memory devices. Non-volatile memory devices may include semiconductor memory devices such as random access memory (RAM), read-only memory (ROM), electrically erasable programmable ROM (EEPROM), or flash memory devices. The non-volatile memory devices may also include magnetic disks (such as internal hard disks or removable disks), optical storage devices (such as compact discs (CDs), digital versatile discs (DVDs), Blu-ray discs), or other media that can store computer-executable instructions or data structures.

### EXAMPLE EMBODIMENTS

Example 1 includes a device comprising: a housing; a modular baseband card (BBC) mounted within the housing, wherein the modular BBC has one or more interfaces; one or more radio modules, wherein at least one radio module in the one or more radio modules is coupled to an interface in the one or more interfaces, wherein the one or more interfaces are capable of connecting to multiple different power classes of radio modules; and one or more additional components in communication with the modular BBC through the one or more interfaces that support operation of a radio module in a respective power class.

Example 2 includes the device of Example 1, wherein the at least one radio module in the different power classes of radio modules is a high-power radio module.

Example 3 includes the device of Example 2, wherein the different power classes of radio modules comprise two or more radios of different power classes.

Example 4 includes the device of any of Examples 1-3, wherein the at least one radio module in the different power classes of radio modules is a medium-power radio module, wherein the medium-power radio module is connected to a power pallet.

Example 5 includes the device of any of Examples 1-4, wherein a duplexer is connected to the radio module through at least one of: a direct connection; and a cable connection.

Example 6 includes the device of any of Examples 1-5, wherein at least one interface in the one or more interfaces comprises a serial peripheral interface (SPI) comprising: a controller; one or more x-to-y line decoders coupled to the controller by a plurality of binary signal lines and a chip-select line, wherein the x-to-y line decoder has a plurality of chip-select outputs, where each chip-select output is associated with a different combination of binary signals transmitted by the controller on the plurality of binary signal lines; and a plurality of SPI devices, each SPI device coupled to the controller by a plurality of lines and to an associated chip-select output of the x-to-y line decoder, wherein an SPI device in the plurality of SPI devices receives a chip-select signal through the associated chip-select output when the x-to-y line decoder receives a combination of binary signals associated with the associated chip-select output.

Example 7 includes the device of Example 6, wherein the one or more x-to-y line decoders comprises a plurality of x-to-y line decoders, wherein each x-to-y line decoder comprises activating logic, wherein the activating logic is coupled to the controller through a plurality of x-to-y line select lines, wherein the x-to-y line select lines are coupled to the controller, and the activating logic activates the x-to-y line decoder for receiving the chip-select signals and the binary signals based on x-to-y line select signals transmitted by the controller.

Example 8 includes the device of any of Examples 6-7, wherein the controller communicates with the plurality of SPI devices through self-addressing circuitry.

Example 9 includes the device of Example 8, wherein the plurality of SPI devices are connected through a cascaded connection and the plurality of SPI devices comprise additional self-addressing circuitry and the plurality of SPI devices have similar circuitry.

Example 10 includes the device of any of Examples 1-9, wherein multiple radio modules in the one or more radio modules are arranged in a power lineup connected to the interface in the one or more interfaces, wherein a lower-power radio module functions as a driver stage for a higher-power radio module.

Example 11 includes the device of Example 10, wherein a digital predistortion (DPD) path extends through the multiple radio modules in the power lineup.

Example 12 includes the device of Example 11, wherein the radio module in the power lineup comprises a DPD switch that switches the DPD path from amplified signals in the radio module and other amplified signals from at least one of the higher-power radio module and a power pallet in the power lineup.

Example 13 includes the device of any of Examples 1-12, wherein a component in the one or more additional components is a data and power entry module.

Example 14 includes the device of Example 13, wherein the interface allows a plurality of different device types to couple in a plurality of different orientations with respect to the modular BBC.

Example 15 includes the device of any of Examples 1-14, wherein pins of the interface are reconfigurable within the BBC.

Example 16 includes the device of Example 15, wherein the pins are reconfigurable by changing at least one of: assembly configurations; FPGA configurations; and software changes.

Example 17 includes the device of any of Examples 1-16, wherein at least one amplifier in the radio module uses reflective splitting when amplifying multiple frequency bands.

Example 18 includes the device of any of Examples 1-17, further comprising a duplexer mounted to an external surface of the housing.

Example 19 includes the device of any of Examples 1-18, wherein the modular BBC comprises an FPGA, and at least one of the radio module in the one or more radio modules and the modular BBC comprises at least one transceiver chip, wherein the FPGA and the at least one transceiver chip each perform a portion of signal processing performed by the device, and wherein, the interface in the one or more interfaces is an analog RF or analog IF interface.

Example 20 includes a distributed antenna system (DAS) comprising: one or more main units configured to communicate with one or more base stations; and a plurality of access points coupled to the one or more main units, wherein the plurality of access points are configured to wirelessly transmit and receive signals from user equipment; wherein at least one of the one or more main units and the plurality of access points further comprises: a modular baseband card (BBC), wherein the modular baseband card has a plurality of interfaces; a data and power entry module coupled to an interface of the modular BBC wherein the modular BBC receives baseband data signals and power through the data and power entry module; and one or more cascaded radio modules, wherein a radio module in a cascaded radio module is coupled to an other interface in the plurality of interfaces, wherein the plurality of interfaces is capable of connecting to multiple different types of radio modules.

Example 21 includes the DAS of Example 20, wherein the interface in the plurality of interfaces comprises a self-addressing serial peripheral interface (SPI) comprising: a controller mounted on the modular BBC; one or more x-to-y line decoders coupled to the controller by a plurality of binary signal lines and a chip-select line, wherein the x-to-y line decoder has a plurality of chip-select outputs, wherein each chip-select output is associated with a different combination of binary signals transmitted by the controller on the plurality of binary signal lines; a plurality of SPI devices, each SPI device coupled to the controller by a plurality of lines and to an associated chip-select output of the x-to-y line decoder, wherein an SPI device in the plurality of SPI devices receives a chip-select signal through the associated chip-select output when the x-to-y line decoder receives a combination of binary signals associated with the associated chip-select output; and self-addressing circuitry, wherein the self-addressing circuitry controls selections of SPI devices in the plurality of SPI devices based on one or more interfaces in the plurality of interfaces through which the device communicates with the controller.

Example 22 includes the DAS of Example 21, wherein the one or more x-to-y line decoders comprises a plurality of x-to-y line decoders, wherein each x-to-y line decoder comprises activating logic, wherein the activating logic is coupled to the controller through a plurality of x-to-y line select lines, wherein the x-to-y line select lines are coupled to the controller, and the activating logic activates the x-to-y line decoder for receiving the chip-select signals and the binary signals based on x-to-y line select signals transmitted by the controller.

Example 23 includes the DAS of Example 22, wherein the self-addressing circuitry for an interface in the one or more interfaces connected to a connected device comprises at least one of: an activation open connection that couples to an input line for the activating logic of the connected device; a binary-signal open connection that couples to a binary signal line of the connected device; an activation ground connection that couples to the input line for the activating logic of the connected device; and a binary-signal ground connection that couples to the binary signal line of the connected device.

Example 24 includes the DAS of any of Examples 22-23, wherein the plurality of SPI devices are connected through a cascaded connection and the plurality of SPI devices comprise additional self-addressing circuitry and the plurality of SPI devices have similar circuitry.

Example 25 includes the DAS of any of Examples 20-24, wherein at least one amplifier in the radio module uses reflective combining when amplifying multiple frequency bands.

Example 26 includes the DAS of any of Examples 20-25, further comprising a duplexer mounted to an external surface of a housing of an access point in the one or more access points.

Example 27 includes a method comprising: exchanging a baseband signal by a modular baseband card (BBC) having a plurality of reconfigurable interfaces through a data and power entry module coupled to the modular BBC; exchanging signals between the modular BBC and one or more radio modules coupled to at least one reconfigurable interface in the plurality of reconfigurable interfaces; and converting the signals for radio frequency transmission and reception within the one or more radio modules, wherein the radio module amplifies downlink signals to a desired power level for transmission into a coverage area.

Example 28 includes the method of Example 27, wherein multiple radio modules in the one or more radio modules are arranged in a power lineup connected to the interface in the plurality of reconfigurable interfaces, wherein a low-power radio module functions as a first driver stage for a medium-power radio module and the medium-power radio module functions as a second driver stage for a power pallet.

Example 29 includes the method of Example 28, wherein a digital predistortion (DPD) path extends through the multiple radio modules in the power lineup, wherein a radio module in the power lineup comprises a DPD switch that switches the DPD path from amplified signals in the radio module and other amplified signals from at least one of a higher-power radio module and the power pallet in the power lineup.

Example 30 includes the method of any of Examples 27-29, further comprising using reflective splitting when amplifying multiple frequency bands.

Example 31 includes the method of any of Examples 27-30, further comprising distributing performance of one or more signal processing operations performed by an FPGA on the modular BBC to at least one transceiver chip located on the one or more radio modules.

Example 32 includes the method of any of Examples 27-31, further comprising coupling a plurality of different devices types in a plurality of different orientations through multiple interfaces in the plurality of reconfigurable interfaces.

Example 33 includes the method of any of Examples 27-32, further comprising reconfiguring one or more pins of the at least one reconfigurable interface by changing at least one of: assembly configurations; FPGA configurations; and software changes.

Example 34 includes the method of any of Examples 27-33, further comprising using reflective splitting to amplify multiple frequency bands in the one or more radio modules.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A device comprising:
a housing;
a modular baseband card (BBC) mounted within the housing, wherein the modular BBC has one or more interfaces;
one or more radio modules, wherein at least one radio module in the one or more radio modules is coupled to an interface in the one or more interfaces, wherein the one or more interfaces are capable of connecting to multiple different power classes of radio modules; and
one or more additional components in communication with the modular BBC through the one or more interfaces that support operation of a radio module in a respective power class.

2. The device of claim 1, wherein the at least one radio module in the different power classes of radio modules is a high-power radio module.

3. The device of claim 2, wherein the different power classes of radio modules comprise two or more radios of different power classes.

4. The device of claim 1, wherein the at least one radio module in the different power classes of radio modules is a medium-power radio module, wherein the medium-power radio module is connected to a power pallet.

5. The device of claim 1, wherein a duplexer is connected to the radio module through at least one of:
a direct connection; and
a cable connection.

6. The device of claim 1, wherein at least one interface in the one or more interfaces comprises a serial peripheral interface (SPI) comprising:
a controller;
one or more x-to-y line decoders coupled to the controller by a plurality of binary signal lines and a chip-select line, wherein the x-to-y line decoder has a plurality of chip-select outputs, where each chip-select output is associated with a different combination of binary signals transmitted by the controller on the plurality of binary signal lines; and
a plurality of SPI devices, each SPI device coupled to the controller by a plurality of lines and to an associated chip-select output of the x-to-y line decoder, wherein an SPI device in the plurality of SPI devices receives a chip-select signal through the associated chip-select output when the x-to-y line decoder receives a combination of binary signals associated with the associated chip-select output.

7. The device of claim 6, wherein the one or more x-to-y line decoders comprises a plurality of x-to-y line decoders, wherein each x-to-y line decoder comprises activating logic, wherein the activating logic is coupled to the controller through a plurality of x-to-y line select lines, wherein the x-to-y line select lines are coupled to the controller, and the activating logic activates the x-to-y line decoder for receiving the chip-select signals and the binary signals based on x-to-y line select signals transmitted by the controller.

8. The device of claim 6, wherein the controller communicates with the plurality of SPI devices through self-addressing circuitry.

9. The device of claim 8, wherein the plurality of SPI devices are connected through a cascaded connection and the plurality of SPI devices comprise additional self-addressing circuitry and the plurality of SPI devices have similar circuitry.

10. The device of claim 1, wherein multiple radio modules in the one or more radio modules are arranged in a power lineup connected to the interface in the one or more interfaces, wherein a lower-power radio module functions as a driver stage for a higher-power radio module.

11. The device of claim 10, wherein a digital predistortion (DPD) path extends through the multiple radio modules in the power lineup.

12. The device of claim 11, wherein the radio module in the power lineup comprises a DPD switch that switches the DPD path from amplified signals in the radio module and other amplified signals from at least one of the higher-power radio module and a power pallet in the power lineup.

13. The device of claim 1, wherein a component in the one or more additional components is a data and power entry module.

14. The device of claim 13, wherein the interface allows a plurality of different device types to couple in a plurality of different orientations with respect to the modular BBC.

15. The device of claim 1, wherein pins of the interface are reconfigurable within the BBC.

16. The device of claim 15, wherein the pins are reconfigurable by changing at least one of:
assembly configurations;
FPGA configurations; and
software changes.

17. The device of claim 1, wherein at least one amplifier in the radio module uses reflective splitting when amplifying multiple frequency bands.

18. The device of claim 1, further comprising a duplexer mounted to an external surface of the housing.

19. The device of claim 1, wherein the modular BBC comprises an FPGA, and at least one of the radio module in the one or more radio modules and the modular BBC comprises at least one transceiver chip, wherein the FPGA and the at least one transceiver chip each perform a portion of signal processing performed by the device, and wherein, the interface in the one or more interfaces is an analog RF or analog IF interface.

20. A distributed antenna system (DAS) comprising:
one or more main units configured to communicate with one or more base stations; and
a plurality of access points coupled to the one or more main units, wherein the plurality of access points are configured to wirelessly transmit and receive signals from user equipment;
wherein at least one of the one or more main units and the plurality of access points further comprises:
a modular baseband card (BBC), wherein the modular baseband card has a plurality of interfaces;
a data and power entry module coupled to an interface of the modular BBC wherein the modular BBC receives baseband data signals and power through the data and power entry module; and
one or more cascaded radio modules, wherein a radio module in a cascaded radio module is coupled to an other interface in the plurality of interfaces, wherein the plurality of interfaces is capable of connecting to multiple different types of radio modules.

21. The DAS of claim 20, wherein the interface in the plurality of interfaces comprises a self-addressing serial peripheral interface (SPI) comprising:
a controller mounted on the modular BBC;
one or more x-to-y line decoders coupled to the controller by a plurality of binary signal lines and a chip-select line, wherein the x-to-y line decoder has a plurality of chip-select outputs, wherein each chip-select output is associated with a different combination of binary signals transmitted by the controller on the plurality of binary signal lines;
a plurality of SPI devices, each SPI device coupled to the controller by a plurality of lines and to an associated chip-select output of the x-to-y line decoder, wherein an SPI device in the plurality of SPI devices receives a chip-select signal through the associated chip-select output when the x-to-y line decoder receives a combination of binary signals associated with the associated chip-select output; and
self-addressing circuitry, wherein the self-addressing circuitry controls selections of SPI devices in the plurality of SPI devices based on one or more interfaces in the plurality of interfaces through which the device communicates with the controller.

22. The DAS of claim 21, wherein the one or more x-to-y line decoders comprises a plurality of x-to-y line decoders, wherein each x-to-y line decoder comprises activating logic, wherein the activating logic is coupled to the controller through a plurality of x-to-y line select lines, wherein the x-to-y line select lines are coupled to the controller, and the activating logic activates the x-to-y line decoder for receiving the chip-select signals and the binary signals based on x-to-y line select signals transmitted by the controller.

23. The DAS of claim 22, wherein the self-addressing circuitry for an interface in the one or more interfaces connected to a connected device comprises at least one of:
an activation open connection that couples to an input line for the activating logic of the connected device;
a binary-signal open connection that couples to a binary signal line of the connected device;
an activation ground connection that couples to the input line for the activating logic of the connected device; and
a binary-signal ground connection that couples to the binary signal line of the connected device.

24. The DAS of claim 22, wherein the plurality of SPI devices are connected through a cascaded connection and the plurality of SPI devices comprise additional self-addressing circuitry and the plurality of SPI devices have similar circuitry.

25. The DAS of claim 20, wherein at least one amplifier in the radio module uses reflective combining when amplifying multiple frequency bands.

26. The DAS of claim 20, further comprising a duplexer mounted to an external surface of a housing of an access point in the one or more access points.

27. A method comprising:
exchanging a baseband signal by a modular baseband card (BBC) having a plurality of reconfigurable interfaces through a data and power entry module coupled to the modular BBC;
exchanging signals between the modular BBC and one or more radio modules coupled to at least one reconfigurable interface in the plurality of reconfigurable interfaces; and
converting the signals for radio frequency transmission and reception within the one or more radio modules, wherein the radio module amplifies downlink signals to a desired power level for transmission into a coverage area.

28. The method of claim 27, wherein multiple radio modules in the one or more radio modules are arranged in a power lineup connected to the interface in the plurality of reconfigurable interfaces, wherein a low-power radio module functions as a first driver stage for a medium-power radio module and the medium-power radio module functions as a second driver stage for a power pallet.

29. The method of claim 28, wherein a digital predistortion (DPD) path extends through the multiple radio modules in the power lineup, wherein a radio module in the power lineup comprises a DPD switch that switches the DPD path from amplified signals in the radio module and other amplified signals from at least one of a higher-power radio module and the power pallet in the power lineup.

30. The method of claim 27, further comprising using reflective splitting when amplifying multiple frequency bands.

31. The method of claim 27, further comprising distributing performance of one or more signal processing operations performed by an FPGA on the modular BBC to at least one transceiver chip located on the one or more radio modules.

32. The method of claim 27, further comprising coupling a plurality of different devices types in a plurality of different orientations through multiple interfaces in the plurality of reconfigurable interfaces.

33. The method of claim 27, further comprising reconfiguring one or more pins of the at least one reconfigurable interface by changing at least one of:
assembly configurations;
FPGA configurations; and
software changes.

34. The method of claim 27, further comprising using reflective splitting to amplify multiple frequency bands in the one or more radio modules.
